(19) United States
(12) Patent Application Publication
(10) Pub. No.: US 2007/0003162 A1
(43) Pub. Date: Jan. 4, 2007

(54) Image generation device, image generation method, and image generation program

(75) Inventors: Takashi Miyoshi, Atsugi (JP); Hidekazu Iwaki, Tokyo (JP); Akio Kosaka, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/519,080

(22) Filed: Sep. 11, 2006

Related U.S. Application Data
(63) Continuation of application No. PCT/JP05/02976, filed on Feb. 24, 2005.

(30) Foreign Application Priority Data
Mar. 11, 2004 (JP) 2004-069237
Mar. 17, 2004 (JP) 2004-075951

(51) Int. Cl. G06K 9/36

(52) U.S. Cl. 382/276

(57) ABSTRACT

The image generation device includes distance calculation means for calculating a distance between a space model and an imaging device arrangement object model which is a model such as a vehicle having a camera mounted, according to viewpoint conversion image data generated by viewpoint conversion means, captured image data representing captured image, a space model, or mapped space data. When displaying an image viewed from an arbitrary virtual viewpoint in the 3D space, the image display format is changed according to the distance calculated by the distance calculation means. When displaying a monitoring object such as a vicinity of a vehicle, a shop, a house or a city as an image viewed from an arbitrary virtual viewpoint in the 3D space, it is possible to display the monitoring object in such a manner that the relationship between the vehicle and the image of the monitoring object can be understood intuitionally.

### CROSS REFERENCE TO RELATED APPLICATIONS

This is a Continuation Application of PCT Application No. PCT/JP2005/002976, filed Feb. 24, 2005, which was not published under PCT Article 21(2) in English.

This application is based upon and claims the benefit of priority from the prior Japanese Patent Application Nos. 2004-069237 and 2004-075951, filed on Mar. 11, 2004 and Mar. 17, 2004, the entire contents of which are incorporated herein by reference.

### BACKGROUND OF THE INVENTION

1. Field of the Invention

The present invention relates to an image generation device, an image generation method and an image generation program for producing image data for displaying an image in such a manner that a relationship between an object and captured images can be understood intuitively when an image obtained by synthesizing, a plurality of images acquired by one or a plurality of cameras mounted on the above object such as a vehicle or the like, based on image data corresponding to respective areas whose images were acquired, is displayed.

The present invention also relates to a device and method for displaying one image obtained by synthesizing a plurality of images acquired by one or a plurality of cameras in such a manner that an entirety of an area whose images are acquired by the above one or a plurality of cameras can be understood intuitively instead of displaying these images independently from one another (e.g., to a technique which can advantageously be applied to a monitor device in a store, a device for monitoring the surroundings of a vehicle for assisting the confirmation of the safety for driving the vehicle or the like).

2. Description of the Related Art

Conventionally, a monitor camera device for monitoring a target, such as the surroundings of a vehicle, of a store, of a house, a city itself or the like, uses one or a plurality of cameras for acquiring images of a monitored target and the captured images are displayed by a monitoring-display device. In such a monitor camera device, in the case where there are not as many monitoring-display devices as the cameras (e.g., in the case where there are two cameras while there is only one monitoring-display device), a plurality of the images acquired by the cameras are displayed in one monitoring-display device together, or these captured images were sequentially switched to be displayed. However, this type of monitor camera device has a problem that an observer has to take continuity of the images displayed independently into consideration in order to monitor the images from the respective cameras.

As solutions for solving this problem, image generation devices that comprehensively display images acquired by a plurality of cameras have been disclosed in recent years (see Patent Document 1 for example). The Patent Document 1 discloses a configuration in which areas (such as the surroundings of a vehicle) whose images are acquired by a plurality of cameras are synthesized into one continuous image and the synthesized image is displayed by an image generation device. Specifically, the Patent Document 1 discloses a technique related to a monitor camera device for displaying a synthesized image which causes a feeling as if the viewer is really seeing the view from a virtual viewpoint using a configuration in which images input from one or a plurality of cameras mounted on a vehicle or the like are mapped onto a predetermined spatial model in a 3D space, the spatial data obtained by the mapping is referred to, and the image viewed from an arbitrary viewpoint in the 3D space is generated and displayed.

Using the above configuration, in the device mounted on the vehicle, one image is obtained by synthesizing a plurality of images in such a manner that it can be understood as easily as possible what kind of objects there are surrounding the vehicle, and the obtained image is provided to the driver. Upon this, it is also possible to display an image from a viewpoint desired by the driver by viewpoint conversion means.

Patent Document 1

Japanese Patent No. 3286306

### SUMMARY OF THE INVENTION

However, the conventional monitor camera device such as the above has a problem that it is difficult to understand the relationship between an image acquisition means arrangement object such as a vehicle on which the camera is mounted and a monitored target whose image is acquired.

The present invention is achieved in view of the above drawback of the conventional technique, and it is an object of the present invention to provide an image generation device, an image generation method and an image generation program which can display an image in such a manner that the relationship between the image acquisition means, arrangement objects (such as a vehicle or the like), and the monitored target whose image is acquired can be understood intuitively when an image of the monitored target (such as the surroundings of a vehicle, of a store, of a house, or a city itself or the like) is displayed as an image viewed from a virtual viewpoint in a 3D space.

In addition, the technique disclosed in the Patent Document 1 is mainly concerned with a method in which images of areas (the surroundings of a vehicle, for example), acquired by a plurality of cameras, are synthesized into one continuous image, the synthesized image is mapped onto a virtual 3D spatial model, and an image (virtual viewpoint image) viewed from a viewpoint shifted virtually in a 3D space is generated based on the data obtained by the mapping. Accordingly, the technique in the Patent Document 1 does not propose an improvement of convenience in a user interface regarding the display, the display format or the like regarding the above image in a sufficiently specific manner.

Therefore, the present invention provides an image generation device that displays the virtual viewpoint image taking the convenience of the user into consideration.

In order to solve the above problems, the present invention employs the configurations as below.

According to one aspect of the present invention, an image generation device of the present invention is an image generation device comprising one or a plurality of image acquisition units which are mounted on an image acquisition unit arrangement object and which are for acquiring images, a space reconfiguration unit for mapping the captured images acquired by the image acquisition units onto a spatial model, a viewpoint conversion unit for producing viewpoint conversion image data of an image viewed from an arbitrary virtual viewpoint in a 3D space (based on spatial data obtained by the mapping by the space reconfiguration unit), and a display unit for displaying the image viewed from the arbitrary virtual viewpoint in a 3D space (based on the viewpoint conversion image data produced by the viewpoint conversion unit), and further comprising a distance calculation unit for calculating a distance between an image acquisition unit arrangement object model as a model of the image acquisition unit arrangement object and the spatial model, based on any of the viewpoint conversion image data produced by the viewpoint conversion unit, the captured image data expressing the captured image, the spatial model, and the spatial data obtained by the mapping, in which the display unit displays the image in a different manner in accordance with the distance calculated by the distance calculation unit.

Additionally, in the image generation device according to the present invention, it is desirable that the display unit displays the image as a background model, including the image when the distance calculated by the distance calculation unit is equal to or larger than a prescribed value.

Additionally, in the image generation device according to the present invention, it is desirable that the display unit display an image with a portion in a blurred state, when the portion whose distance calculated by the distance calculation unit is equal to or larger than a prescribed value is included in the image which is to be displayed.

Additionally, according to another aspect of the present invention, the image generation device of the present invention is an image generation device comprising one or a plurality of image acquisition units which are mounted on an image acquisition unit arrangement object and which are for acquiring images, a space reconfiguration unit for mapping the captured images acquired by the image acquisition units onto a spatial model, a viewpoint conversion unit for producing viewpoint conversion image data of an image viewed from an arbitrary virtual viewpoint in a 3D space (based on spatial data obtained by the mapping by the space reconfiguration unit), and a display unit for displaying the image viewed from the arbitrary virtual viewpoint in a 3D space (based on the viewpoint conversion image data produced by the viewpoint conversion unit), and further comprising a relative velocity calculation unit for calculating a relative velocity between an image acquisition unit arrangement object model (as a model of the image acquisition unit arrangement object and the spatial model), based on any of the viewpoint conversion image data at two time points which correspond to different time points and which is produced by the viewpoint conversion unit, the captured image data expressing the captured image, the spatial model and the spatial data obtained by the mapping, in which the display unit displays the image in a different manner in accordance with the relative velocity calculated by the relative velocity calculation unit.

Additionally, according to another aspect of the present invention, the image generation device of the present invention is an image generation device comprising one or a plurality of image acquisition units which are mounted on an image acquisition unit arrangement object and which are for acquiring images, a space reconfiguration unit for mapping the captured images acquired by the image acquisition units onto a spatial model, a viewpoint conversion unit for producing viewpoint conversion image data of an image viewed from an arbitrary virtual viewpoint in a 3D space (based on spatial data obtained by the mapping by the space reconfiguration unit), and a display unit for displaying the image viewed from the arbitrary virtual viewpoint in a 3D space (based on the viewpoint conversion image data produced by the viewpoint conversion unit), and further comprising a collision probability calculation unit for calculating a probability of a collision between an image acquisition unit arrangement object model (as a model of the image acquisition unit arrangement object and the spatial model), based on any of the viewpoint conversion image data that corresponds to different time points and which is produced by the viewpoint conversion unit, the captured image data expressing the captured image, and the spatial model and the spatial data obtained by the mapping, in which the display unit displays the image in a different manner in accordance with the probability of a collision calculated by the collision probability calculation unit.

Additionally, in the image generation device according to the present invention, it is desirable that the display unit displays the image as a background model including the image when the probability of a collision calculated by the collision probability calculation unit is equal to or smaller than a prescribed value.

Additionally, in the image generation device according to the present invention, it is desirable that the display unit displays an image with a portion in a blurred state, when the portion whose probability of a collision calculated by the collision probability calculation unit is equal to or smaller than a prescribed value is included in the image which is to be displayed.

Additionally, in the image generation device according to the present invention, it is desirable that the display unit is configured so as to be able to employ the manner of the display such that the meaning of displayed information is recognized by a color.

Additionally, in the image generation device according to the present invention, it is desirable that the display unit is configured so as to be able to employ a manner of a display in which at least one of the hue, saturation and/or brightness of a color used for the display is different in accordance with the distance calculated by the distance calculation unit.

Additionally, in the image generation device according to the present invention, it is desirable that the display unit is configured so as to be able to employ a manner of a display in which at least one of the hue, saturation and/or brightness of a color used for the display differs in accordance with the plurality of grades defined by distance values calculated by the distance calculation unit to which the distance value calculated by the distance calculation unit corresponds.

Additionally, in the image generation device according to the present invention, it is desirable that the image acquisition unit is mounted on a vehicle.

Additionally, according to another aspect of the present invention, the image generation method of the present invention is an image generation method executed by a computer, including mapping captured images acquired by one or a plurality of image acquisition units that are mounted on an image acquisition unit arrangement object and are for acquiring images onto a spatial model, producing viewpoint conversion image data of an image viewed from an arbitrary virtual viewpoint in a 3D space (based on spatial data obtained by the mapping), and displaying the image viewed from the arbitrary virtual viewpoint in a 3D space (based on the produced viewpoint conversion image data), in which the distance between an image acquisition unit arrangement object model as a model of the image acquisition unit arrangement object and the spatial model is further calculated, based on any of the produced viewpoint conversion image data, the captured image data expressing the captured image, the spatial model and the spatial data obtained by the mapping, and the image is displayed in a different manner in accordance with the calculated distance.

Additionally, according to another aspect of the present invention, the image generation method of the present invention is an image generation method executed by a computer, including mapping captured images acquired by one or a plurality of image acquisition units which are mounted on an image acquisition unit arrangement object and which are for acquiring images onto a spatial model, producing viewpoint conversion image data of an image viewed from an arbitrary virtual viewpoint in a 3D space (based on spatial data obtained by the mapping), and displaying the image viewed from the arbitrary virtual viewpoint in a 3D space (based on the produced viewpoint conversion image data), in which the relative velocity between an image acquisition unit arrangement object model as a model of the image acquisition unit arrangement object and the spatial model is further calculated, based on any of the produced viewpoint conversion image data that corresponds to different time points, the captured image data expressing the captured image, the spatial model and the spatial data obtained by the mapping, and the image is displayed in a different manner in accordance with the calculated relative velocity.

Additionally, according to another aspect of the present invention, the image generation method of the present invention is an image generation method executed by a computer, including mapping captured images acquired by one or a plurality of image acquisition units that are mounted on an image acquisition unit arrangement object and which are for acquiring images onto a spatial model, producing viewpoint conversion image data of an image viewed from an arbitrary virtual viewpoint in a 3D space (based on spatial data obtained by the mapping), and displaying the image viewed from the arbitrary virtual viewpoint in a 3D space (based on the produced viewpoint conversion image data), in which the probability of a collision between an image acquisition unit arrangement object model (as a model of the image acquisition unit arrangement object) and the spatial model is further calculated, based on any of the produced viewpoint conversion image data which corresponds to different time points, the captured image data expressing the captured image, the spatial model and the spatial data obtained by the mapping, and the image is displayed in a different manner in accordance with the calculated probability of a collision.

Additionally, according to another aspect of the present invention, the image generation program of the present invention is an image generation program for causing a computer to execute a step of mapping captured images acquired by one or a plurality of image acquisition units which are mounted on an image acquisition unit arrangement object and which are for acquiring images onto a spatial model, a step of producing viewpoint conversion image data of an image viewed from an arbitrary virtual viewpoint in a 3D space (based on spatial data obtained by the mapping), and a step of displaying the image viewed from the arbitrary virtual viewpoint in a 3D space (based on the produced viewpoint conversion image data), further comprising a step of calculating a distance between an image acquisition unit arrangement object model as a model of the image acquisition unit arrangement object and the spatial model (based on any of the produced viewpoint conversion image data, the captured image data expressing the captured image, the spatial model and the spatial data obtained by the mapping), in which, in the step of displaying, the image is displayed in a different manner in accordance with the calculated distance.

Additionally, according to another aspect of the present invention, the image generation program of the present invention is an image generation program for causing a computer to execute a step of mapping captured images acquired by one or a plurality of image acquisition units which are mounted on an image acquisition unit arrangement object and which are for acquiring images onto a spatial model, a step of producing viewpoint conversion image data of an image viewed from an arbitrary virtual viewpoint in a 3D space, based on spatial data obtained by the mapping, and a step of displaying the image viewed from the arbitrary virtual viewpoint in a 3D space, based on the produced viewpoint conversion image data, further comprising a step of calculating a relative velocity between an image acquisition unit arrangement object model as a model of the image acquisition unit arrangement object and the spatial model, based on any of the produced viewpoint conversion image data which corresponds to different time points, the captured image data expressing the captured image, the spatial model and the spatial data obtained by the mapping, in which the image is displayed in a different manner in accordance with the calculated relative velocity.

Additionally, according to another aspect of the present invention, the image generation program of the present invention is an image generation program for causing a computer to execute a step of mapping captured images acquired by one or a plurality of image acquisition units which are mounted on an image acquisition unit arrangement object and which are for acquiring images onto a spatial model, a step of producing viewpoint conversion image data of an image viewed from an arbitrary virtual viewpoint in a 3D space, based on spatial data obtained by the mapping, and a step of displaying the image viewed from the arbitrary virtual viewpoint in a 3D space, based on the produced viewpoint conversion image data, further comprising a step of calculating a probability of a collision between an image acquisition unit arrangement object model as a model of the image acquisition unit arrangement object and the spatial model, based on any of the produced viewpoint conversion image data which corresponds to different time points, the viewpoint conversion image data, the captured image data expressing the captured image, the spatial model and the spatial data obtained by the mapping, in which the image is displayed in a different manner in accordance with the calculated probability of a collision.

Additionally, according to another aspect of the present invention, the image generation device of the present invention is an image generation device comprising a space reconfiguration unit for mapping images input from one or a plurality of cameras mounted on a vehicle onto a spatial model, a vehicle movement detection unit for detecting a movement of the vehicle, a virtual viewpoint setting unit for obtaining blind spot information specifying a blind spot for a person in the vehicle based on the result of the detection and for setting a virtual viewpoint in a 3D space based on the blind spot information, a view point conversion unit for generating a virtual viewpoint image that is an image viewed from the virtual viewpoint in a 3D space by referring to the spatial data obtained by the mapping by the space reconfiguration unit, and a display control unit for controlling a manner of display of the virtual viewpoint image.

Thereby, the virtual viewpoint image of the portion in the blind spot for the driver can be displayed in accordance with the movement of the vehicle.

Additionally, in the image generation device according to the present invention, it is desirable that the display control unit is configured to control a display such that the blind spot can be distinguished from other portions in a virtual viewpoint image including the blind spot and portions around the blind spot.

Thereby, the virtual viewpoint image can be displayed in such a manner that the area in the blind spot is distinguished from the area around the blind spot.

Additionally, in the image generation device according to the present invention, it is desirable that the display control unit is configured to control a display of the virtual viewpoint image such that a color of the blind spot comes out differently from that of other portions in order that the blind spot can be distinguished from other portions.

Thereby, the virtual viewpoint image can be displayed in such a manner that the area in the blind spot is distinguished from the area around the blind spot.

Additionally, in the image generation device according to the present invention, it is desirable that the virtual viewpoint setting unit obtains, as the blind spot information, information regarding the occurrence trend of a blind spot which changes depending on the operations of the vehicle, and adaptively sets the virtual viewpoint in a 3D space such that the set virtual viewpoint is suitable for the occurrence trend of the blind spot.

Thereby, the virtual viewpoint image can be displayed in accordance with the occurrence trend of the blind spot, which changes depending upon the operations.

Additionally, according to another aspect of the present invention, the image generation device of the present invention is an image generation device comprising a space reconfiguration unit for mapping images input from one or a plurality of cameras mounted on a vehicle onto a spatial model, a viewpoint conversion unit for generating a virtual viewpoint image that is an image viewed from an arbitrary virtual viewpoint in a 3D space by referring to the spatial data obtained by the mapping by the space reconfiguration unit, a display unit for displaying the virtual viewpoint image, and a display control unit for controlling a manner of display of the virtual viewpoint image in order to cause the display unit arranged on a part that is in the vehicle and that causes a blind spot for a person in the vehicle to display the virtual viewpoint image corresponding to a view which can not be seen in the blind spot.

Thereby, the display device arranged on the surface of the part causing the blind spot can display the virtual viewpoint image corresponding to a view without the part causing the blind spot.

Additionally, according to another aspect of the present invention, the image generation device of the present invention is an image generation device comprising a space reconfiguration unit for mapping images input from one or a plurality of cameras mounted on a vehicle onto a spatial model, a viewpoint conversion unit for generating a virtual viewpoint image that is an image viewed from an arbitrary virtual viewpoint in a 3D space by referring to the spatial data obtained by the mapping by the space reconfiguration unit, a display unit for displaying the virtual viewpoint image, and a display control unit for controlling a manner of display of the virtual viewpoint image in order to display the virtual viewpoint image that is the virtual viewpoint image of the virtual viewpoint in a direction of virtual reflection by the display unit and in which a view in a blind spot which can not be seen by a person in a vehicle is added such that the blind spot does not occur when the person in the vehicle sees the display unit.

Thereby, the display unit can have a function of a rear view mirror and the view over the part causing the blind spot can be displayed.

Additionally, in the image generation device according to the present invention, it is desirable that the virtual viewpoint image under the control of the display control unit is displayed in such a manner that an area corresponding to the view added such that the view in the blind spot which can not be seen does not occur is emphasized.

Thereby, it is possible that the virtual viewpoint image of the view, which could not be seen in the blind spot without the present invention, is distinguished from another view.

Additionally, in the image generation device according to the present invention, it is desirable that the display control unit causes the display unit to display the virtual viewpoint image with a wide field of view by bending the virtual viewpoint image.

Thereby, the display device can have an effect of a convex mirror.

Additionally, according to another aspect of the present invention, the image generation program of the present invention is an image generation program for causing a computer to execute a space reconfiguration process of mapping images input from one or a plurality of cameras mounted on a vehicle onto a spatial model, a vehicle movement detection process for detecting a movement of the vehicle, a virtual viewpoint setting process of obtaining blind spot information specifying a blind spot for a person in the vehicle based on the result of the detection and of setting a virtual viewpoint in a 3D space based on the blind spot information, a viewpoint conversion process of generating a virtual viewpoint image (an image viewed from the virtual viewpoint in a 3D space by referring to the spatial data obtained by the mapping in the space reconfiguration process), and a display process of displaying the virtual viewpoint image.

Thereby, the virtual viewpoint image of the portion in the blind spot for the driver can be displayed in accordance with the movement of the vehicle.

Additionally, according to another aspect of the present invention, the image generation program of the present invention is an image generation program for causing a computer to execute a space reconfiguration process of mapping images input from one or a plurality of cameras mounted on a vehicle onto a spatial model, a viewpoint conversion process of generating a virtual viewpoint image that is an image viewed from an arbitrary virtual viewpoint in a 3D space by referring to the spatial data obtained by the mapping in the space reconfiguration process, and a display control process of controlling a manner of display of the virtual viewpoint image in order to cause a display unit arranged on a part that is in the vehicle and that causes a blind spot for a person in the vehicle to display the virtual viewpoint image corresponding to a view which can not be seen in the blind spot.

Thereby, the virtual viewpoint image corresponding to the view, without the part causing the blind spot, can be displayed by the display unit arranged on the surface of the part causing the blind spot.

Additionally, according to another aspect of the present invention, the image generation program of the present invention is an image generation program for causing a computer to execute a space reconfiguration process of mapping images input from one or a plurality of cameras mounted on a vehicle onto a spatial model, a viewpoint conversion process of generating a virtual viewpoint image that is an image viewed from an arbitrary virtual viewpoint in a 3D space by referring to the spatial data obtained by the mapping in the space reconfiguration process, and a display control process of controlling a manner of display of the virtual viewpoint image in order to display the virtual viewpoint image that is the virtual viewpoint image of the virtual viewpoint in a direction of virtual reflection by a display unit and in which a view in a blind spot which cannot be seen by a person in a vehicle is added such that the blind spot does not occur when the person in the vehicle sees the display unit.

Thereby, the display unit can have the function of the rear view mirror and the view over the part causing the blind spot can be displayed.

Additionally, according to another aspect of the present invention, the image generation method of the present invention is an image generation method comprising execution of a space reconfiguration step of mapping images input from one or a plurality of cameras mounted on a vehicle onto a spatial model, a vehicle movement detection step of detecting a movement of the vehicle, a virtual viewpoint setting step of obtaining blind spot information specifying a blind spot for a person in the vehicle based on the result of the detection, and of setting a virtual viewpoint in a 3D space based on the blind spot information, a viewpoint conversion step of generating a virtual viewpoint image (which is an image viewed from the virtual viewpoint in a 3D space by referring to the spatial data obtained by the mapping in the space reconfiguration step), and a display step of displaying the virtual viewpoint image.

Thereby, the virtual viewpoint image of the portion in the blind spot for the driver can be displayed in accordance with the movement of the vehicle.

Additionally, according to another aspect of the present invention, the image generation method of the present invention is an image generation method comprising execution of a space reconfiguration step of mapping images input from one or a plurality of cameras mounted on a vehicle onto a spatial model, a viewpoint conversion step of generating a virtual viewpoint image that is an image viewed from an arbitrary virtual viewpoint in a 3D space by referring to the spatial data obtained by the mapping in the space reconfiguration step, and a display control step of controlling a manner of display of the virtual viewpoint image in order to cause the display unit arranged on a part that is in the vehicle and that causes a blind spot for a person in the vehicle to display the virtual viewpoint image corresponding to a view which can not be seen in the blind spot.

Thereby, the display unit arranged on the surface of the part causing the blind spot can display the virtual viewpoint image corresponding to the view without the part causing the blind spot for the driver.

Additionally, according to another aspect of the present invention, the image generation method of the present invention is an image generation method comprising execution of a space reconfiguration step of mapping images input from one or a plurality of cameras mounted on a vehicle onto a spatial model, a viewpoint conversion step of generating a virtual viewpoint image that is an image viewed from an arbitrary virtual viewpoint in a 3D space by referring to the spatial data obtained by the mapping in the space reconfiguration step, and a display control step of controlling a manner of display of the virtual viewpoint image in order to display the virtual viewpoint image that is the virtual viewpoint image of the virtual viewpoint in a direction of virtual reflection by a display unit and in which a view in a blind spot which can not be seen by a person in a vehicle is added such that the blind spot does not occur when the person in the vehicle sees the display unit.

Thereby, the display unit can have the function of the rear view mirror and the view over the part causing the blind spot can be displayed.

Additionally, according to another aspect of the present invention, the image generation device of the present invention is an image generation device comprising a space reconfiguration unit for mapping images input from one or a plurality of cameras mounted on an image acquisition unit arrangement object onto a spatial model, an image acquisition unit arrangement object movement detection unit for detecting a movement of the image acquisition unit arrangement object, a virtual viewpoint setting unit for obtaining blind spot information specifying a blind spot for an observer operating the image acquisition unit arrangement object based on the result of the detection, and for setting a virtual viewpoint in a 3D space based on the blind spot information, a viewpoint conversion unit for generating a virtual viewpoint image (which is an image viewed from the virtual viewpoint in a 3D space by referring to the spatial data obtained by the mapping by the space reconfiguration unit), and a display control unit for controlling a manner of display of the virtual viewpoint image.

Thereby, the virtual viewpoint image of the portion in the blind spot for the user can be displayed in accordance with the movement of the image acquisition unit arrangement object.

Additionally, in the image generation device according to the present invention, it is desirable that the display control unit is configured to control a display such that the blind spot can be distinguished from other portions in a virtual viewpoint image including the blind spot and portions around the blind spot.

Thereby, the virtual viewpoint image can be displayed in such a manner that the area in the blind spot is distinguished from the area around the blind spot.

Additionally, in the image generation device according to the present invention, it is desirable that the display control unit is configured to control a display of the virtual viewpoint image such that a color of the blind spot comes out differently from that of other portions in order that the blind spot can be distinguished from other portions.

Thereby, the virtual viewpoint image can be displayed in such a manner that the area in the blind spot is distinguished from the area around the blind spot.

Additionally, in the image generation device according to the present invention, it is desirable that the virtual viewpoint setting unit is configured to obtain, as the blind spot information, information regarding occurrence trends of a blind spot which changes depending on operations on the image acquisition unit arrangement object, and to adaptively set the virtual viewpoint in a 3D space such that the set virtual viewpoint is suitable for the occurrence trend of the blind spot.

Thereby, the virtual viewpoint image can be displayed in accordance with the occurrence trend of the blind spot, which changes depending upon the operations.

Additionally, according to another aspect of the present invention, the image generation device of the present invention is an image generation device comprising a space reconfiguration unit for mapping images input from one or a plurality of cameras mounted on an image acquisition unit arrangement object onto a spatial model, a viewpoint conversion unit for generating a virtual viewpoint image that is an image viewed from an arbitrary virtual viewpoint in a 3D space by referring to the spatial data obtained by the mapping by the space reconfiguration unit, a display unit for displaying the virtual viewpoint image, and a display control unit for controlling a manner of display of the virtual viewpoint image in order to cause the display unit arranged on a part which is in the image acquisition unit arrangement object and which causes a blind spot for an observer to display the virtual viewpoint image corresponding to a view which can not be seen in the blind spot.

Thereby, the display unit arranged on the surface of the part causing the blind spot can display the virtual viewpoint image corresponding to the view without the part causing the blind spot for the driver.

Additionally, according to another aspect of the present invention, the image generation device of the present invention is an image generation device comprising a space reconfiguration unit for mapping images input from one or a plurality of cameras mounted on an image acquisition unit arrangement object onto a spatial model, a viewpoint conversion unit for generating a virtual viewpoint image that is an image viewed from an arbitrary virtual viewpoint in a 3D space by referring to the spatial data obtained by the mapping by the space reconfiguration unit, a display unit for displaying the virtual viewpoint image, and a display control unit for controlling a manner of display of the virtual viewpoint image in order to display the virtual viewpoint image that is the virtual viewpoint image of the virtual viewpoint in a direction of virtual reflection by the display unit and in which a view in a blind spot which can not be seen by an observer is added such that the blind spot does not occur when the observer sees the display unit.

Thereby, the display unit can have the function of the rear view mirror and the view over the part causing the blind spot can be displayed.

Additionally, in the image generation device according to the present invention, it is desirable that the virtual viewpoint image under the control of the display control unit is displayed in such a manner that an area corresponding to the view added, such that the view in the blind spot which cannot be seen does not occur, is emphasized.

Thereby, it is possible that the virtual viewpoint image of the view, which could not be seen in the blind spot without the present invention, is distinguished from other view.

Additionally, in the image generation device according to the present invention, it is desirable that the display control unit causes the display unit to display the virtual viewpoint image with a wide field of view by bending the virtual viewpoint image.

Thereby, the display device can have the effect of the convex mirror.

Additionally, according to another aspect of the present invention, the image generation program of the present invention is an image generation program for causing a computer to execute a space reconfiguration process of mapping images input from one or a plurality of cameras mounted on an image acquisition unit arrangement object onto a spatial model, an image acquisition unit arrangement object movement detection process of detecting a movement of the image acquisition unit arrangement object, a virtual viewpoint setting process of obtaining blind spot information specifying a blind spot for an observer operating the image acquisition unit arrangement object based on the result of the detection, and of setting the virtual viewpoint in a 3D space based on the blind spot information, a viewpoint conversion process of generating a virtual view point image that is an image viewed from the virtual viewpoint in a 3D space by referring to the spatial data obtained by the mapping in the space reconfiguration process, and a display process of displaying the virtual viewpoint image.

Thereby, the virtual viewpoint image of the portion in the blind spot for the user can be displayed in accordance with the movement of the image acquisition unit arrangement object.

Additionally, according to another aspect of the present invention, the image generation program of the present invention is an image generation program for causing a computer to execute a space reconfiguration process of mapping images input from one or a plurality of cameras mounted on an image acquisition unit arrangement object onto a spatial model, a viewpoint conversion process of generating a virtual viewpoint image that is an image viewed from an arbitrary virtual viewpoint in a 3D space by referring to the spatial data obtained by the mapping in the space reconfiguration process, and a display control process of controlling a manner of display of the virtual viewpoint image in order to cause a display unit arranged on a part which is in the image acquisition unit arrangement object and which causes a blind spot for an observer to display the virtual viewpoint image corresponding to a view which can not be seen in the blind spot.

Thereby, the display unit arranged on the surface of the part causing the blind spot can display the virtual viewpoint image corresponding to the view without the part causing a blind spot for the user.

Additionally, according to another aspect of the present invention, the image generation program of the present invention is an image generation program for causing a computer to execute a space reconfiguration process of mapping images input from one or a plurality of cameras mounted on an image acquisition unit arrangement object onto a spatial model, a viewpoint conversion process of generating a virtual viewpoint image that is an image viewed from an arbitrary virtual viewpoint in a 3D space by referring to the spatial data obtained by the mapping in the space reconfiguration process, and a display control process of controlling a manner of display of the virtual viewpoint image in order to display the virtual viewpoint image that is the virtual viewpoint image of the virtual viewpoint in a direction of virtual reflection by a display unit and in which a view in a blind spot which can not be seen by an observer is added such that the blind spot does not occur when the observer sees the display unit.

Thereby, the display unit can have the function of the rear view mirror and the view over the part causing the blind spot can be displayed.

Additionally, according to another aspect of the present invention, the image generation method of the present invention is an image generation method comprising execution of a space reconfiguration step of mapping images input from one or a plurality of cameras mounted on an image acquisition unit arrangement object onto a spatial model, an image acquisition unit arrangement object movement detection step of detecting a movement of the image acquisition unit arrangement object, a virtual viewpoint setting step of obtaining blind spot information specifying a blind spot for an observer operating the image acquisition unit arrangement object based on the result of the detection, and of setting a virtual viewpoint in a 3D space based on the blind spot information, a viewpoint conversion step of generating a virtual viewpoint image that is an image viewed from the virtual view point in a 3D space by referring to the spatial data obtained by the mapping in the space reconfiguration step, and a display step of displaying the virtual viewpoint image.

Thereby, the virtual viewpoint image of the portion in the blind spot for the user can be displayed in accordance with the movement of the image acquisition unit arrangement object.

Additionally, according to another aspect of the present invention, the image generation method of the present invention is an image generation method comprising execution of a space reconfiguration step of mapping images input from one or a plurality of cameras mounted on an image acquisition unit arrangement object onto a spatial model, a viewpoint conversion step of generating a virtual viewpoint image that is an image viewed from an arbitrary virtual viewpoint in a 3D space by referring to the spatial data obtained by the mapping in the space reconfiguration step, and a display control step of controlling a manner of display of the virtual viewpoint image in order to cause a display unit arranged on a part which is in the image acquisition unit arrangement object and which causes a blind spot for an observer to display the virtual viewpoint image corresponding to a view which can not be seen in the blind spot.

Thereby, the display unit arranged on the surface of the part causing the blind spot can display the virtual viewpoint image corresponding to the view without the part causing the blind spot for the user.

Additionally, according to another aspect of the present invention, the image generation method of the present invention is an image generation method comprising execution of a space reconfiguration step of mapping images input from one or a plurality of cameras mounted on an image acquisition unit arrangement object onto a spatial model, a viewpoint conversion step of generating a virtual viewpoint image that is an image viewed from an arbitrary virtual viewpoint in a 3D space by referring to the spatial data obtained by the mapping in the space reconfiguration step, and a display control step of controlling a manner of display of the virtual viewpoint image in order to display the virtual viewpoint image that is the virtual viewpoint image of the virtual viewpoint in a direction of virtual reflection by a display unit and in which a view in a blind spot which can not be seen by an observer is added such that the blind spot does not occur when the observer sees the display unit.

Thereby, the display unit can have the function of the rear view mirror and the view over the part causing the blind spot can be displayed.

### BRIEF DESCRIPTION OF THE DRAWINGS

FIG. 1 is a block diagram of an image generation device for generating a spatial model by a distance measurement device, and for generating a viewpoint conversion image;

FIG. 2 is a block diagram of the image generation device for generating the spatial model by camera units, and for generating the viewpoint conversion image;

FIG. 3 is a block diagram of the image generation device for generating the spatial model by the distance measurement device, and for displaying the viewpoint conversion image in such a manner that a distance between objects can be understood;

FIG. 4 shows a situation in a field of view that a driver driving a vehicle can experience;

FIG. 5 shows an example of displaying an image in a different manner in accordance with a relative distance between two objects;

FIG. 6 is a block diagram of the image generation device for generating the spatial model by the camera units and for displaying the viewpoint conversion image in such a manner that the distance between objects is understood;

FIG. 7 is a block diagram of the image generation device for generating the spatial model by the distance measurement device, and for displaying the viewpoint conversion image in such a manner that the relative velocity between objects is understood;

FIG. 8 shows an example of displaying an image in a different manner in accordance with the relative velocity between two objects;

FIG. 9 is a block diagram of the image generation device for generating the spatial model by the camera units, and for displaying the viewpoint conversion image in such a manner that the relative velocity between objects is understood;

FIG. 10 is a block diagram of the image generation device for generating the spatial model by the distance measurement device, and for displaying the viewpoint conversion image in such a manner that a probability of a collision between objects is understood;

FIG. 11 shows a relationship between the use's vehicle and another vehicle for explaining an example of calculation of the probability of a collision;

FIG. 12 shows relative vector for explaining the example of the calculation of the probability of a collision;

FIG. 13 shows an example of displaying an image in a different manner in accordance with the probability of a collision between two objects;

FIG. 14 is a block diagram of the image generation device for generating the spatial model by the camera units and for displaying the viewpoint conversion image in such a manner that the probability of a collision between objects is understood;

FIG. 15 is a flowchart for showing a flow of an image generation process of displaying in such a manner that the distance between objects is understood in the viewpoint conversion image;

FIG. 16 is a flowchart for showing a flow of the image generation process of displaying in such a manner that the relative velocity between objects is understood;

FIG. 17 a flowchart for showing a flow of the image generation process of displaying in such a manner that the probability of a collision between objects is understood;

FIG. 18 explains an embodiment in which the present invention is applied to indoor monitoring cameras;

FIG. 19 shows an image generation device 10000 according to a third embodiment of the present invention;

FIG. 20 shows a flow of the display process of the virtual viewpoint image in the third embodiment of the present invention;

FIG. 21 shows an example of detecting a blind spot for a driver based on driving operations by the driver in the third embodiment of the present invention;

FIG. 22 shows examples of modes of movements of a vehicle in the third embodiment of the present invention;

FIG. 23 shows the case where the image generation device according to a fourth embodiment of the present invention is used (first);

FIG. 24 shows the case where the image generation device according to the fourth embodiment of the present invention is used (second);

FIG. 25 shows a flow of displaying the virtual viewpoint image according to the fourth embodiment of the present invention;

FIG. 26 shows the image generation device 10000 according to a fifth embodiment of the present invention;

FIG. 27 shows a manner of display on a display unit according to the fifth embodiment of the present invention (first);

FIG. 28 shows a manner of display on a display unit according to the fifth embodiment of the present invention (second);

FIG. 29 shows an example of the case where the image generation device according to a sixth embodiment of the present invention is applied to a HMD (Head Mounted Display) (first);

FIG. 30 shows an example of the case where the image generation device according to the sixth embodiment of the present invention is applied to the HMD (Head Mounted Display) (second); and

FIG. 31 is a block diagram of a configuration of hardware of the image generation device 10000 according to the third to sixth embodiments.

### DETAILED DESCRIPTION OF THE PREFERRED EMBODIMENTS

Hereinafter, embodiments of the present invention will be described by referring to the drawings.

It is to be noted that the present invention incorporates the technical contents disclosed in the Patent Document 1.

### First Embodiment

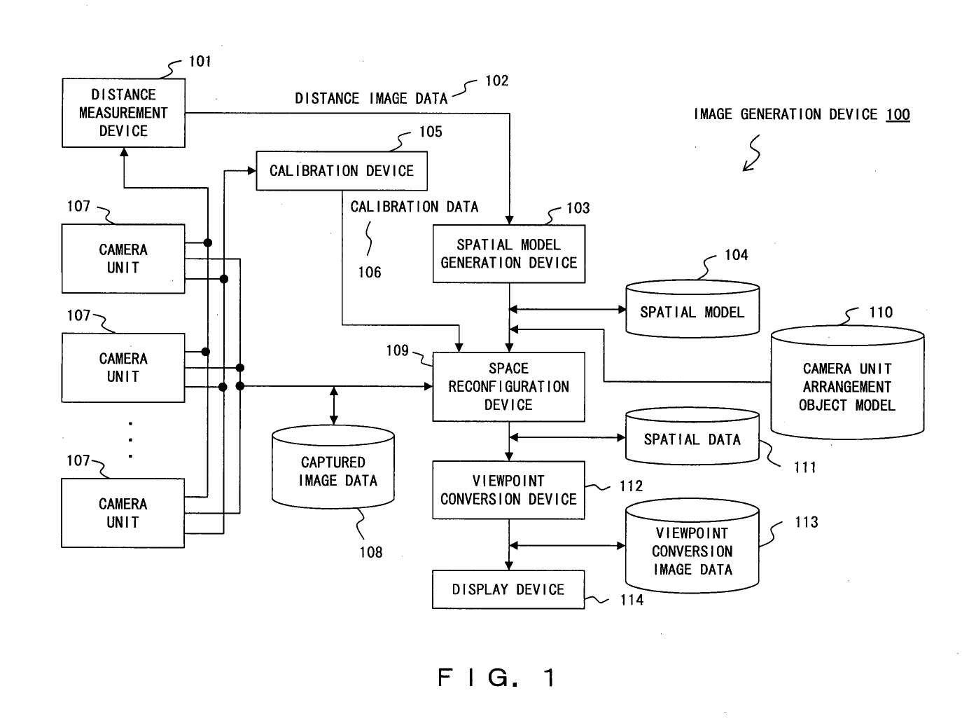

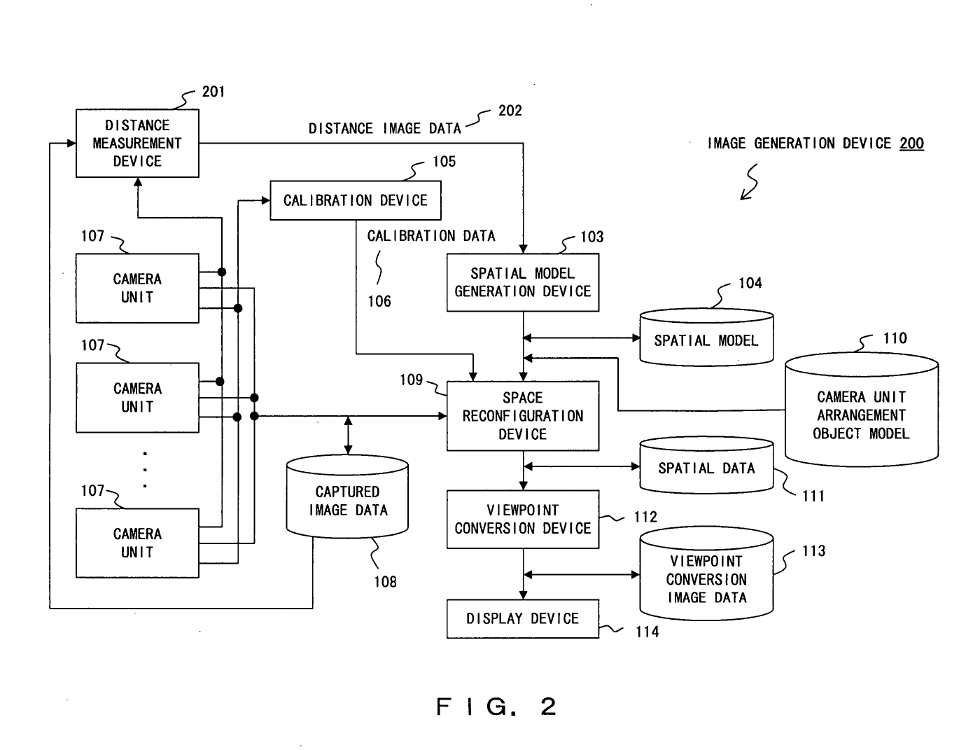

First, an image generation device for generating an image viewed from a virtual viewpoint based on image data acquired by a plurality of cameras, and for displaying the image viewed from the virtual viewpoint will be explained by referring to FIG. 1 and FIG. 2. Additionally, a plurality of cameras are used in the examples of these figures, however, it is possible to acquire, by sequentially changing the arrangement position of one camera, image acquisition data that is equivalent to that acquired in the case where a plurality of cameras are provided. The above one or a plurality of cameras is arranged in an image acquisition means arrangement object such as a vehicle, a room (a particular zone of the room or the like), a building or the like. This point is applied to the examples explained below.

FIG. 1 is a block diagram of the image generation device for generating a spatial model by a distance measurement device, and for generating a viewpoint conversion image.

In FIG. 1, an image generation device 100 comprises a distance measurement device 101, a spatial model generation device 103, a calibration device 105, one or a plurality of camera units 107, a space reconfiguration device 109, a viewpoint conversion device 112 and a display device 114.

The distance measurement device 101 measures a distance to a target (obstacle) by using a distance sensor for measuring a distance. For example, when being mounted on a vehicle, the distance measurement device 101 measures at least a distance to an obstacle being around the vehicle as the situation around the vehicle by using the above distance sensor.

The spatial model generation device 103 generates a spatial model 104 in a 3D space based on distance image data 102 acquired by the distance measurement device 101, and stores the generated spatial model 104 in a database (in the figure, the concept of the database is shown in a form of the actual database, and this is applied to all the figures). Additionally, the spatial model 104 is generated based on the measurement data by the external sensor as described above, or is prescribed, or is generated each time based on a plurality of input images, and is stored in the database.

The camera unit 107 is a camera for example, and is mounted on the camera unit arrangement object for acquiring images and storing the images in the database as captured image data 108. If the camera unit arrangement object is a vehicle, the camera unit 107 acquires images of the surroundings of the vehicle.

The space reconfiguration device 109 performs mapping of the captured image data 108 acquired by the camera unit 107 onto the spatial model 104 generated by the spatial model generation device 103. Then, data obtained by mapping the captured image data 108 onto the spatial model 104 is stored in the database as spatial data.

The calibration device 105 obtains parameters such as positions at which the camera units 107 are mounted, angles at which the camera units 107 are mounted, correlation values for lens distortion, focal lengths of lenses and the like via input by the user or by calculation in order to correct distortion of the lenses caused by variation of temperature for example. In other words, when the camera unit 107 is a camera, camera calibration is conducted. The camera calibration is to determine and to correct camera parameters specifying the camera's characteristics in a 3D real word, such as the position at which the camera is mounted, the angle at which the camera is mounted, the correction value for lens distortion of the camera, the focal length of the camera and the like regarding the camera arranged in a 3D real world.

The viewpoint conversion device 112 produces viewpoint conversion image data 113 as viewed from an arbitrary viewpoint in a 3D space based on spatial data 111 obtained by mapping by the space reconfiguration device 109.

The display device 114 displays an image viewed from an arbitrary virtual viewpoint in the above 3D space based on the viewpoint conversion image data 113 produced by the viewpoint conversion device 112.

FIG. 2 is a block diagram of the image generation device for generating the spatial model by the camera units, and for generating the viewpoint conversion image.

In FIG. 2, an image generation device 200 comprises a distance measurement device 201, the spatial model generation device 103, the calibration device 105, one or a plurality of camera units 107, the space reconfiguration device 109, the viewpoint conversion device 112 and the display device 114.

The image generation device 200 is different from the image generation device 100 explained in FIG. 1 only in the point that the image generation device 200 comprises the distance measurement device 201 in place of the corresponding distance measurement device 101. Hereinbelow, the explanation is mainly of the distance measurement device 201, and the explanation of the other components will be omitted because these components are the same as those of FIG. 1.

The distance measurement device 201 measures a distance to an obstacle based on the captured image data 108 acquired by the camera unit 107. Additionally, the distance measurement device 201 may produce distance image data 202 by using the above measured distance and the data obtained by measuring the distance to the obstacle by using the distance sensor similarly to the distance measurement device 101.

Then, the spatial model generation device 103 generates the spatial model 104 in 3D space based on the distance image data 202 obtained by the measurement by the above distance measurement device 201, and stores the spatial model 104 in a database.

Next, the image generation device which can display the objects in a different manner in accordance with a relative distance between two objects upon displaying the image viewed from the virtual viewpoint. This image generation device can be applied to the image generation devices explained in FIG. 1 and FIG. 2.

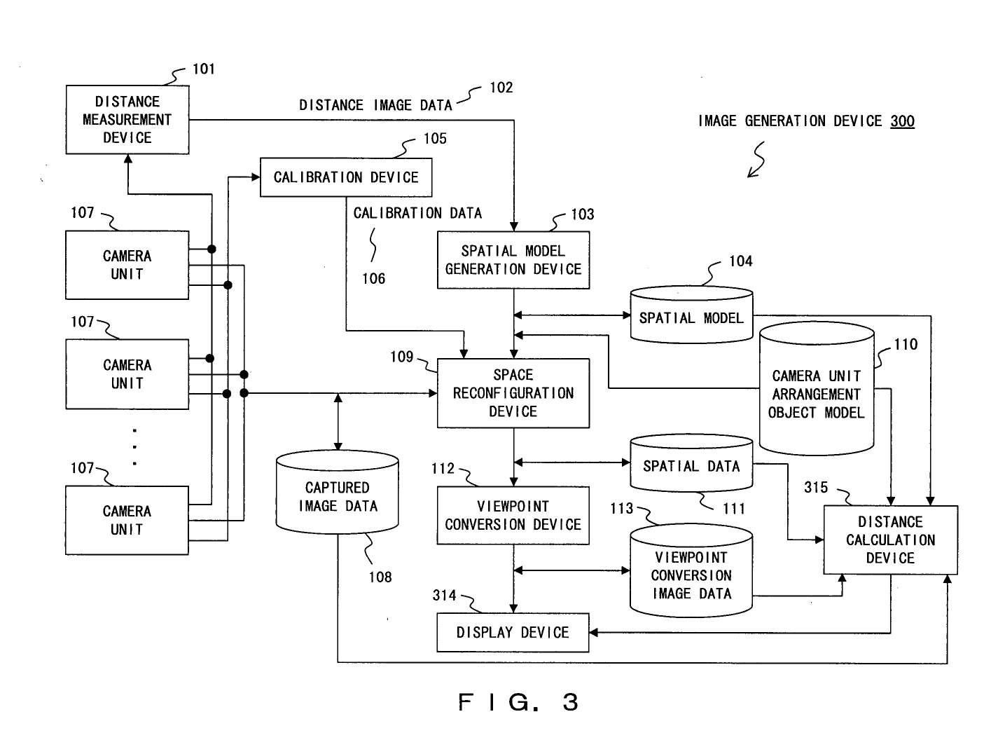

FIG. 3 is a block diagram of the image generation device for generating a spatial model by a distance measurement device, and for displaying the viewpoint conversion image in such a manner that the distances between objects can be understood.

In FIG. 3, an image generation device 300 comprises the distance measurement device 101, the spatial model generation device 103, the calibration device 105, one or a plurality of camera units 107, the space reconfiguration device 109, the viewpoint conversion device 112, a display device 314 and a distance calculation device 315.

The image generation device 300 is different from the image generation device 100 explained in FIG. 1 only in the point that the image generation device 300 comprises the distance calculation device 315 and comprises the display device 314 in place of the corresponding display device 114. Hereinbelow, the explanation is mainly of the display device 314 and the distance calculation device 315, and the explanation of the other components will be omitted because these components are the same as those of FIG. 1.

The distance calculation device 315 calculates the distance between the spatial model 104 and an camera unit arrangement object model 110, which is a model of the corresponding camera unit arrangement object, based on one of the viewpoint conversion image data 113 produced by the viewpoint conversion device 112, the captured image data 108 expressing the captured image, the spatial model 104 and the spatial data 111 obtained by the mapping. For example, in the case when the distance between the camera unit arrangement object model 110 and the spatial model 104 is to be calculated by using the captured image data 108 and the camera unit arrangement object model 110, the distance can be obtained by generating a stereo image by using a plurality of the camera units 107.

Then, the a display device 314 displays the image in a different manner in accordance with the distance calculated by the distance calculation device 315 upon displaying the image viewed from an arbitrary virtual viewpoint in a 3D space based on the viewpoint conversion image data 113 produced by the viewpoint conversion device 112.

Additionally, when the distance calculated by the above distance calculation device 315 is equal to or larger than a prescribed value, the display device 114 may display the image as a background model including the corresponding images. Alternatively, when the image to be displayed includes a portion with the distance calculated by the distance calculation device 315 that is equal to or larger than the prescribed value, the corresponding portion in the image can be in a blurred state.

Additionally, the above display device 114 may display differently in at least one of the factors of hue, saturation and brightness used for the display, in accordance with the distance calculated by the distance calculation device 315, and the display device 114 may also display differently in at least one of the factors of hue, saturation and brightness used for the display, in accordance with which of a plurality of grades defined by the distance values calculated by the distance calculation device 315 the distance value currently calculated by the distance calculation device 315 corresponds to.

Additionally, the above display device 114 may display in such a manner that meaning of the displayed information is understood by the color.

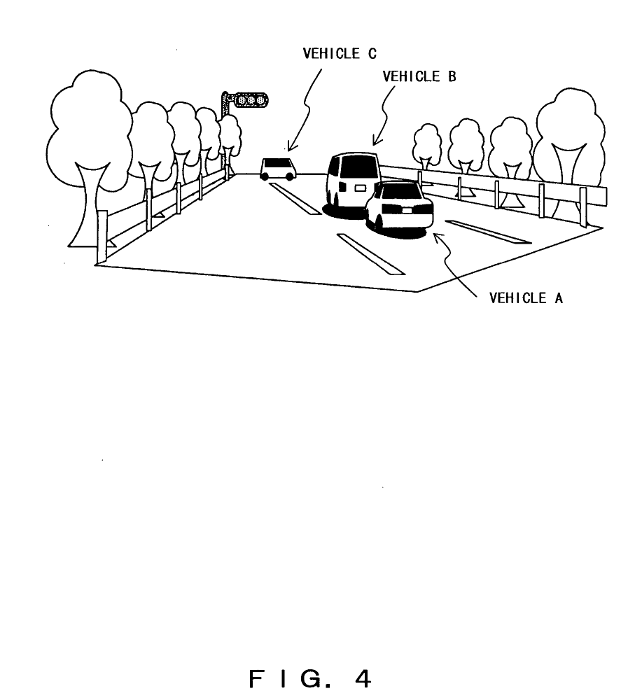

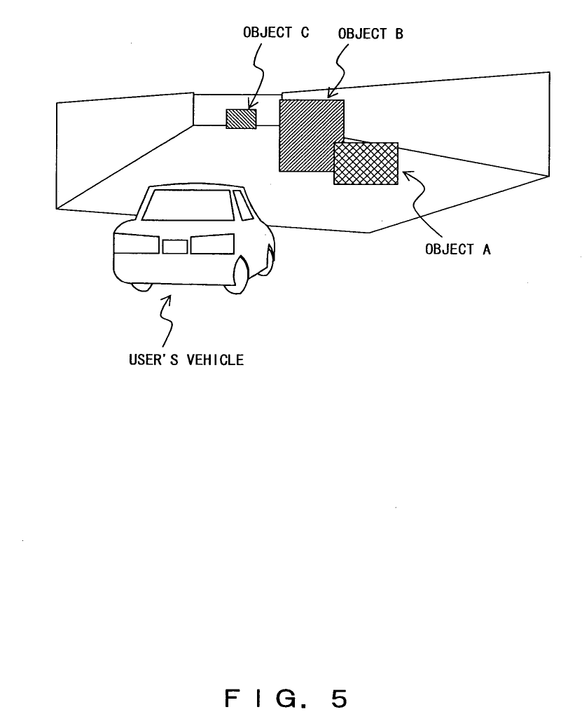

Here, the case where the image generation device 300 is applied as a system for monitoring the surroundings of a vehicle is explained by referring to FIG. 4 and FIG. 5.

FIG. 4 shows a situation in a field of view that a driver driving a vehicle can experience. The driver can see three vehicles of a vehicle A, a vehicle B and a vehicle C on the road.

On the vehicle of the above driver, a distance sensor (the distance measurement device 101) for measuring distances to obstacles being around the vehicle, and a plurality of cameras (camera units 107) for acquiring images of the surroundings of the vehicle are mounted.

The spatial model generation device 103 generates the spatial model 104 in the 3D space based on the distance image data 102 acquired by the distance sensor, and stores the generated spatial model 104 in the database. Then, the cameras capture images of the surroundings of the vehicle, and store the captured images as the captured image data 108 in the database.

The space reconfiguration device 109 maps the captured image data 108 acquired by the cameras onto the spatial model 104 generated by the spatial model generation device 103, and stores the spatial model 104 as the spatial data 111 in the database.

The viewpoint conversion device 112 sets the position which is behind and above the driver's vehicle as the virtual viewpoint for example and produces the viewpoint conversion image data 113 as viewed from the virtual viewpoint based on the spatial data 111 obtained by mapping by the above space reconfiguration device 109, and stores the viewpoint conversion image data 113 in the database.

The distance calculation device 315 calculates the distance between the spatial model 104 and the camera unit arrangement object model 110, which is data of a model of the driver's vehicle based on one of the viewpoint conversion image data 113 produced by the viewpoint conversion device 112, the captured image data 108 expressing the captured image, the spatial model 104 and the spatial data 111 obtained by the mapping. For example, the distance calculation device 315 calculates the distance from the driver's vehicle and another vehicle in front of the driver's vehicle.

The display device 314 is generally arranged in a vehicle and displays the image in a different manner in accordance with the distance calculated by the distance calculation device 315 upon displaying the image viewed from an arbitrary virtual viewpoint in the 3D space based on the viewpoint conversion image data 113 produced by the viewpoint conversion device 112 by sharing a monitor-display device with a car navigation system for example. For example, in the case when there is a plurality of vehicles in front of the driver's vehicle, the vehicles are displayed in different colors or the portions of the vehicles blink at different intervals in accordance with the distances from the driver's vehicle (user's vehicle).

FIG. 5 shows an example of displaying the image in a different manner in accordance with relative distance between two objects.

In FIG. 5, an object A is displayed as the viewpoint conversion image of the vehicle A of FIG. 4, similarly, an object B and an object C are viewpoint conversion images respectively of the vehicle B and the vehicle C. The manner of displaying the objects A, B and C are different in accordance with the distances from the user's vehicle. For example, the object A which is the viewpoint conversion image of the vehicle A being closest to the user's vehicle among the three vehicles is displayed in red, the object B which is the viewpoint conversion image of the vehicle B being secondary closest to the user's vehicle is displayed in yellow, and the object C which is the viewpoint conversion image of the farthest vehicle C is displayed in green.

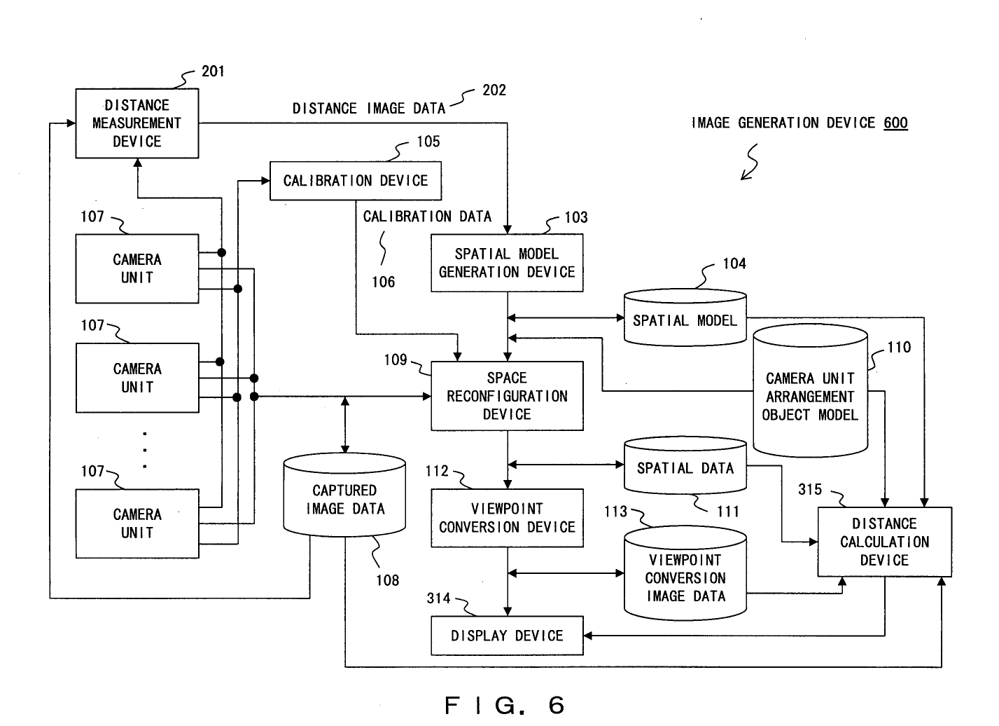

FIG. 6 is a block diagram of the image generation device for generating a spatial model by the camera units and for displaying a viewpoint conversion image in such a manner that the distances between objects are understood.

In FIG. 6, an image generation device 600 comprises the distance measurement device 201, the spatial model generation device 103, the calibration device 105, one or a plurality of camera units 107, the space reconfiguration device 109, the viewpoint conversion device 112, the display device 314 and the distance calculation device 315.

The image generation device 600 is different from the image generation device 300 explained in FIG. 3 only in the point that the image generation device 600 comprises the distance measurement device 201 in place of the corresponding distance measurement device 101. The distance measurement device 201 is already explained by referring to FIG. 2, accordingly, the explanation thereof is omitted.

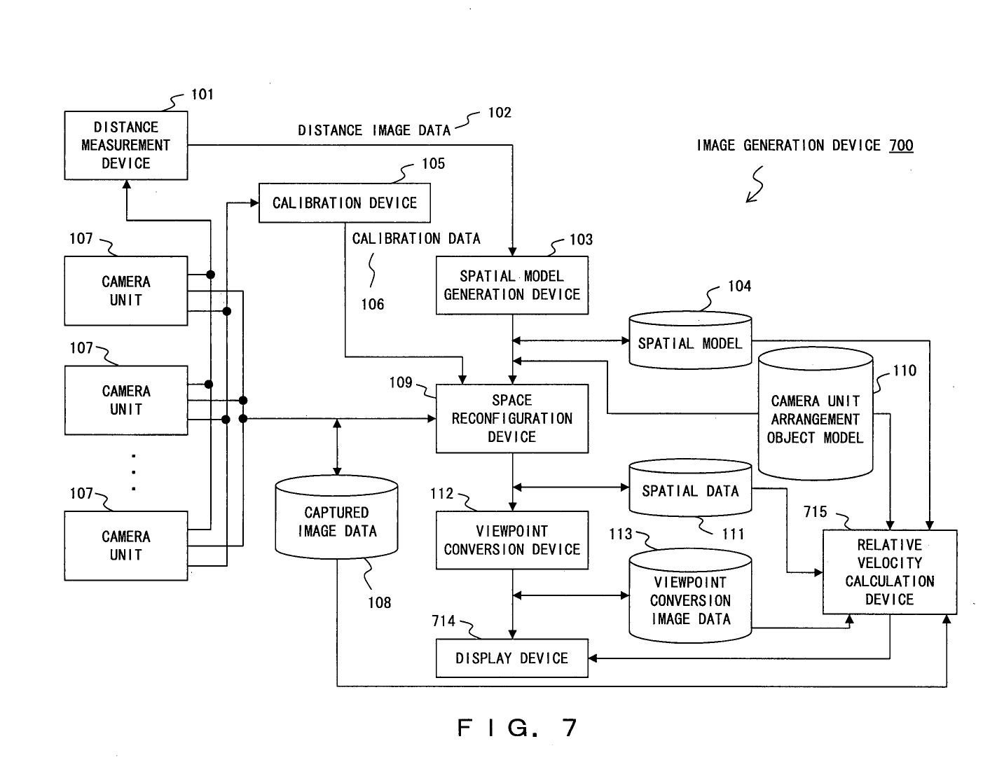

Next, the image generation device that can display objects in a different manner in accordance with the relative velocity between two objects upon displaying the image viewed from an arbitrary virtual viewpoint will be explained by referring to FIG. 7 to FIG. 9. This image generation device can be applied to the image generation devices explained in FIG. 1 and FIG. 2.

FIG. 7 is a block diagram of the image generation device for generating a spatial model by the distance measurement device, and for displaying a viewpoint conversion image in such a manner that the relative velocity between objects is understood.

In FIG. 7, an image generation device 700 comprises the distance measurement device 101, the spatial model generation device 103, the calibration device 105, one or a plurality of camera units 107, the space reconfiguration device 109, the viewpoint conversion device 112, the display device 714 and a relative velocity calculation device 715.

The image generation device 700 is different from the image generation device 100 explained in FIG. 1 only in the point that the image generation device 700 comprises the relative velocity calculation device 715, and comprises the display device 714 in place of the corresponding display device 114. Hereinbelow, the explanation is mainly of the relative velocity calculation device 715 and the display device 714, and the explanation of the other components will be omitted because these components are the same as those of FIG. 1.

The relative velocity calculation device 715 calculates a relative velocity between the spatial model 104 and the camera unit arrangement object model 110 which is a model of the corresponding camera unit arrangement object as the driver's vehicle based on one of the viewpoint conversion image data 113 at two points of time, which was produced by the viewpoint conversion device 112, the captured image data 108 expressing the captured image, the spatial model 104 and the spatial data 111 obtained by the mapping.

Then, the display device 714 displays objects in a different manner in accordance with the relative velocity calculated by the relative velocity calculation device 715 upon displaying the image viewed from an arbitrary virtual viewpoint in a 3D space based on the viewpoint conversion image data 113 produced by the viewpoint conversion device 112.

Additionally, the display device 714 may display in such a manner that meaning of the displayed information is understood by the color.

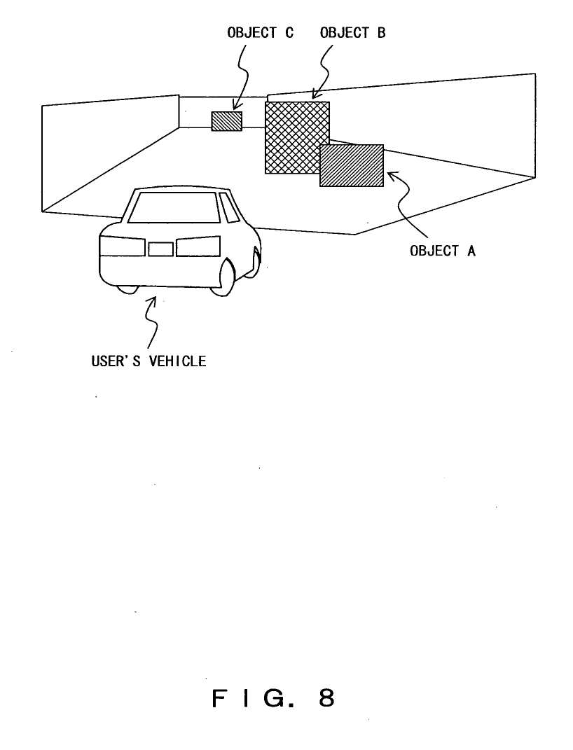

Here, the case where the image generation device 700 is applied as a system for monitoring the situation around a vehicle is explained by referring to FIG. 4 and FIG. 8.

As previously explained, FIG. 4 shows a situation in a field of view that a driving of a vehicle may experience. The driver can see three vehicles of a vehicle A, a vehicle B and a vehicle C on the road.

On the vehicle, a distance sensor (the distance measurement device 101) for measuring distances to obstacles being around the vehicle, and a plurality of cameras (camera units 107) for acquiring images of the surroundings of the vehicle are mounted. For example, when the position behind and above the driver's vehicle is set as the virtual viewpoint, the viewpoint conversion image data 113 as viewed from the virtual viewpoint is produced by the spatial model generation device 103, the space reconfiguration device 109 and the viewpoint conversion device 112, and the viewpoint conversion image data 113 is stored in the database.

The relative velocity calculation device 715 calculates a relative velocity between the spatial model 104 and the camera unit arrangement object model 110, which is a model of the corresponding camera unit arrangement object as the driver's vehicle based on one of the viewpoint conversion image data 113 at two points of time, which was produced by the viewpoint conversion device 112, the captured image data 108 expressing the captured image, the spatial model 104 and the spatial data 111 obtained by the mapping. For example, the relative velocity calculation device 715 calculates the relative velocity between the driver's vehicle and another vehicle in front of the driver's vehicle.

The display device 714 is generally arranged in a vehicle and displays the image in a different manner in accordance with the relative velocity calculated by the relative velocity calculation device 715 upon displaying the image viewed from an arbitrary virtual viewpoint in the 3D space based on the viewpoint conversion image data 113 produced by the viewpoint conversion device 112 by sharing a monitor-display device with a car navigation system for example. For example, in the case when there is a plurality of vehicles in front of the driver's vehicle, the vehicles are displayed in different colors or the portions of the vehicles blink at different intervals in accordance with the relative velocities between the driver's vehicle (user's vehicle) and other vehicles.

FIG. 8 shows an example of displaying image in a different manner in accordance with relative velocity between two objects.

In FIG. 8, an object A is displayed as the viewpoint conversion image of the vehicle A in FIG. 4, similarly, an object B and an object C are viewpoint conversion images respectively of the vehicle B and the vehicle C. The manner of displaying the objects A, B and C are different in accordance with the respective velocities between the user's vehicle and the vehicles A, B and C. For example, the object B which is the viewpoint conversion image of the vehicle B with the highest relative velocity with respect to the user's vehicle among the three vehicles is displayed in red, the object A which is the viewpoint conversion image of the vehicle A with secondary highest relative velocity with respect to the user's vehicle is displayed in yellow, and the object C which is the viewpoint conversion image of the vehicle C with the lowest relative velocity is displayed in green.

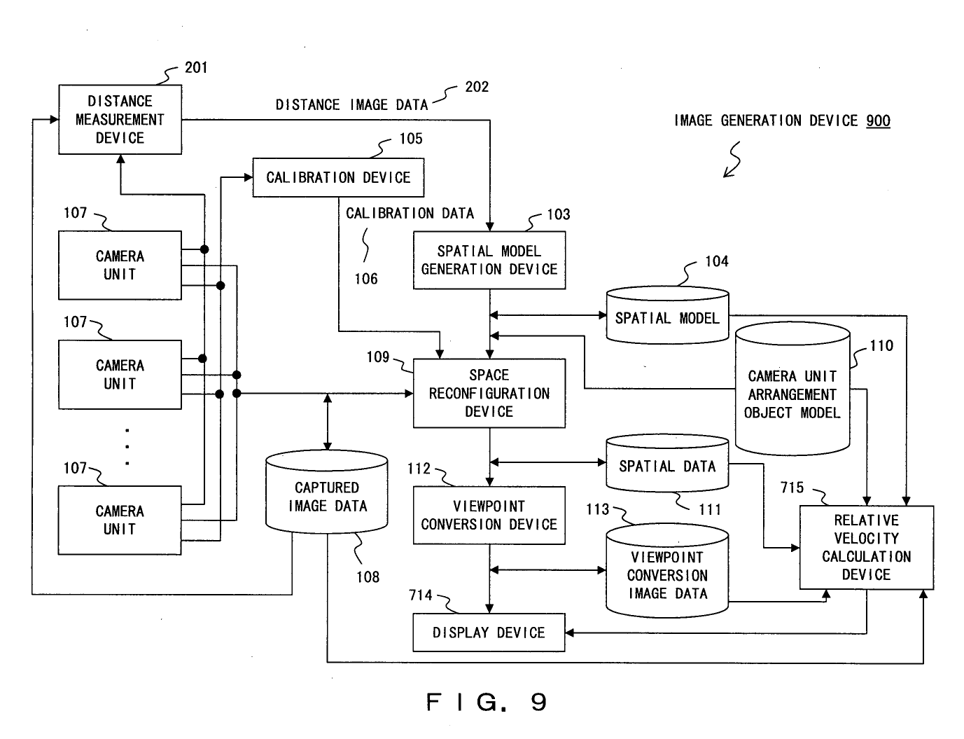

FIG. 9 is a block diagram of the image generation device for generating a spatial model by the camera units, and for displaying a viewpoint conversion image in such a manner that the relative velocity between objects is understood.

In FIG. 9, an image generation device 900 comprises the distance measurement device 201, the spatial model generation device 103, the calibration device 105, one or a plurality of camera units 107, the space reconfiguration device 109, the viewpoint conversion device 112, the display device 714 and the relative velocity calculation device 715.

The image generation device 900 is different from the image generation device 700 explained in FIG. 7 only in the point that the image generation device 900 comprises the distance measurement device 201 in place of the corresponding distance measurement device 101. The explanation of the distance measurement device 201 will be omitted because the distance measurement device 201 is already explained in FIG. 2.

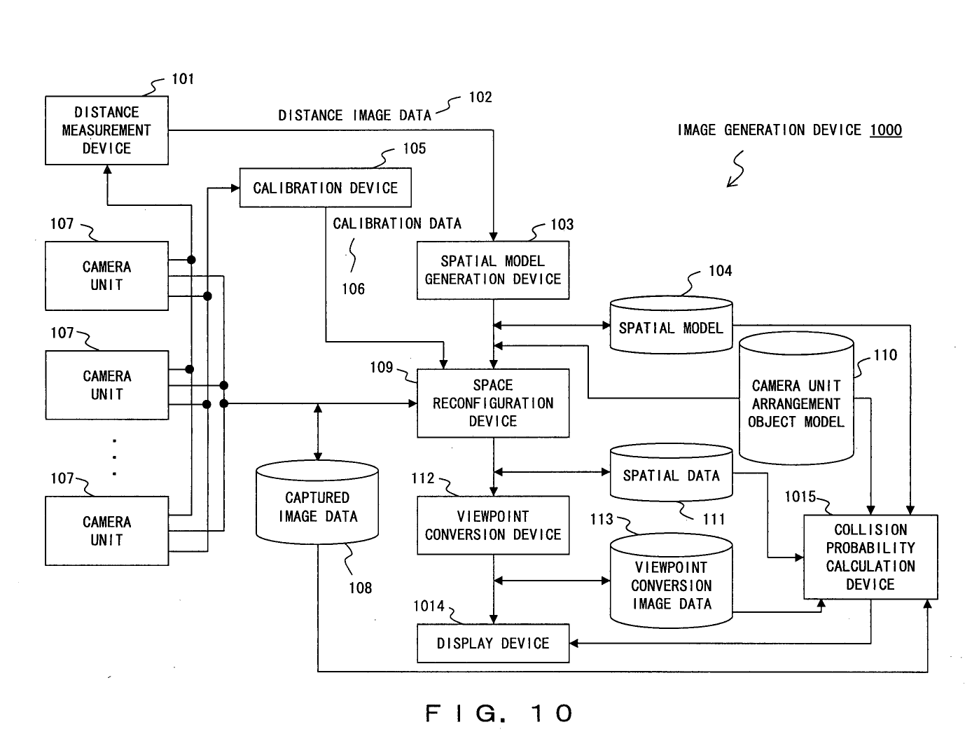

Next, the image generation device that can display objects in a different manner in accordance with the probability of a collision between two objects upon displaying the image viewed from an arbitrary virtual viewpoint will be explained by referring to FIG. 10 to FIG. 14. This image generation device can be applied to the image generation devices explained in FIG. 1 and FIG. 2.

FIG. 10 is a block diagram of the image generation device for generating a spatial model by the distance measurement device, and for displaying a viewpoint conversion image in such a manner that a probability of a collision between objects is understood.

In FIG. 10, an image generation device 1000 comprises the distance measurement device 101, the spatial model generation device 103, the calibration device 105, one or a plurality of camera units 107, the space reconfiguration device 109, the viewpoint conversion device 112, a display device 1014 and a collision probability calculation device 1015.

The image generation device 1000 is different from the image generation device 100 explained in FIG. 1 only in the point that the image generation device 1000 comprises the collision probability calculation device 1015, and comprises the display device 1014 in place of the corresponding display device 114. Hereinbelow, the explanation is mainly of the collision probability calculation device 1015 and the display device 1014, and the explanation of the other components will be omitted because these components are the same as those of FIG. 1.

The collision probability calculation device 1015 calculates the probability of the collision between the spatial model 104 and the camera unit arrangement object model 110 which is a model of the corresponding camera unit arrangement object as the driver's vehicle based on one of the viewpoint conversion image data 113 at two points of time, which was produced by the viewpoint conversion device 112, the captured image data 108 expressing the captured image, the spatial model 104 and the spatial data 111 obtained by the mapping. The probability of the collision can easily be calculated based on a traveling direction and a traveling velocity of each of the two objects for example.

Then, the above display device 1014 displays the image in a different manner in accordance with the probability of the collision calculated by the collision probability calculation device 1015 upon displaying the image viewed from an arbitrary virtual viewpoint in a 3D space based on the viewpoint conversion image data 113 produced by the viewpoint conversion device 112.

In the above example of FIG. 4, the objects are displayed in red, yellow, green and blue in the order from the object with the highest probability of the collision calculated, however, it is also possible that these colors are made different simply in accordance with the distances or the relative velocities.

For example, it is possible that the guardrail portion close to the user's vehicle in distance is displayed in red, and the guardrail portion that is far from the user's vehicle (for example, the guardrail on the side of the opposite lane) is displayed in blue. It is also possible that the course is displayed in blue or green even if it is far from the user's vehicle because the course is the area on which vehicles including the user's vehicle travel.

It is possible that the probability of the collision of each vehicle is calculated based on the relative velocity, the distance and the like among the objects in the viewpoint conversion images, and the vehicles are displayed in different colors in accordance with the variation of the probability of the collision in such a manner that the vehicle with the high probability of the collision calculated is displayed in red, and the vehicle with the low probability of the collision calculated is displayed in green.

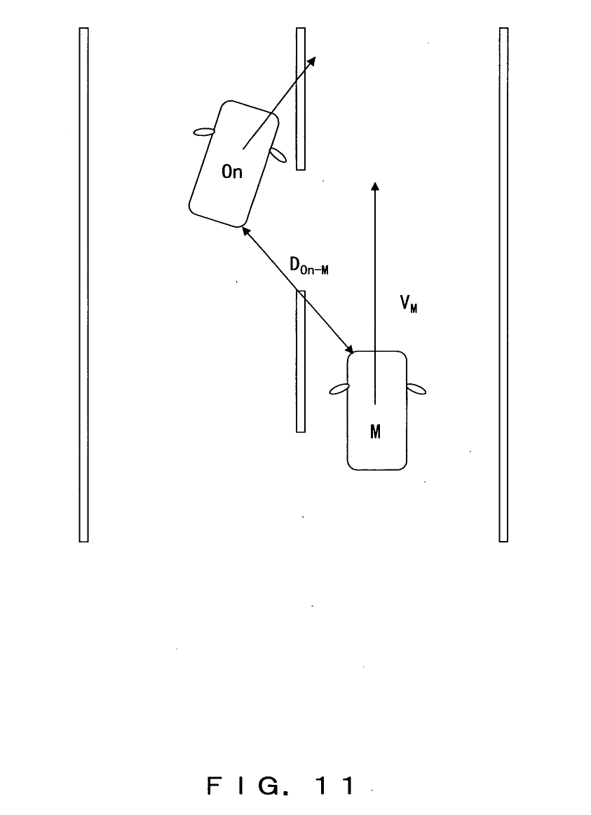

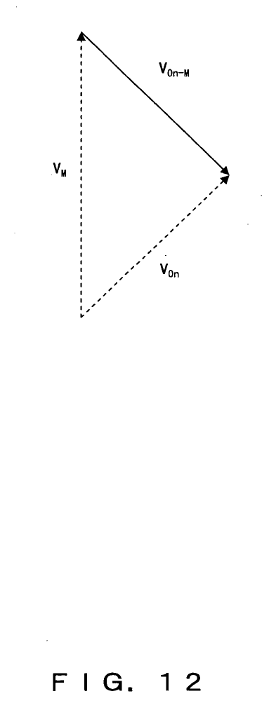

Next, an example of calculating the probability of the collision will be explained by referring to FIG. 11 and FIG. 12.

FIG. 11 shows a relationship between the use's vehicle and another vehicle for explaining the example of calculation of the probability of the collision. FIG. 12 shows relative vector for explaining the calculation of the probability of the collision.

The relationship between the user's vehicle M traveling in an upward direction of the figure on a right lane and a vehicle On which travels in an upward direction of the figure on the left lane and which is entering the right lane for example can be expressed as below.

The relative vector V_{On-M} between the vehicle On (Vₒₙ) and the user's vehicle M(V_{M}) is obtained, and the value (|V_{On-M}|)/D_{On-M} obtained by dividing the value |V_{On-M}| which is the absolute value of the above obtained V_{On-M} by the distance Don-M between the vehicle On and the user's vehicle M is used as the probability of the collision. Alternatively, it is possible that in the case that the distance is shorter and the higher probability of the collision is assumed, the above division is performed by using (D_{On-M})² which is the square of D_{on-M} in place of D_{On-M} in order to improve the accuracy in obtaining the probability of the collision.

In the present embodiment, the manner of the display of the areas with the high probability of the collision is changed by the difference in the hue, based on the distance and the relative velocity between the user's vehicle and other vehicles, and based on the probability of the collision calculated from these distance and relative velocity.

Further, it is possible that the degree of the probability of the collision is expressed by displaying the viewpoint conversion image in a blurred state. For example, the object which is thought to have a low risk of the collision based on the distance, the relative velocity or the probability of the collision is displayed in a blurred state to some extent, and the object which is thought to have a high risk of the collision is displayed clearly in order that the object with the high risk of the collision can be recognized surely.

Thereby, drivers and pedestrians can understand risk of collision more intuitively, and a safe drive and a safe walk are realized.

Additionally, when the probability of the collision calculated by the collision probability calculation device 1015 is equal to lower than a prescribed value, the display device 1014 may display the image as a background model including the corresponding image, or may display the image in a blurred state.

Additionally, the display device 1014 may display in such a manner that meaning of the displayed information is understood by the color.

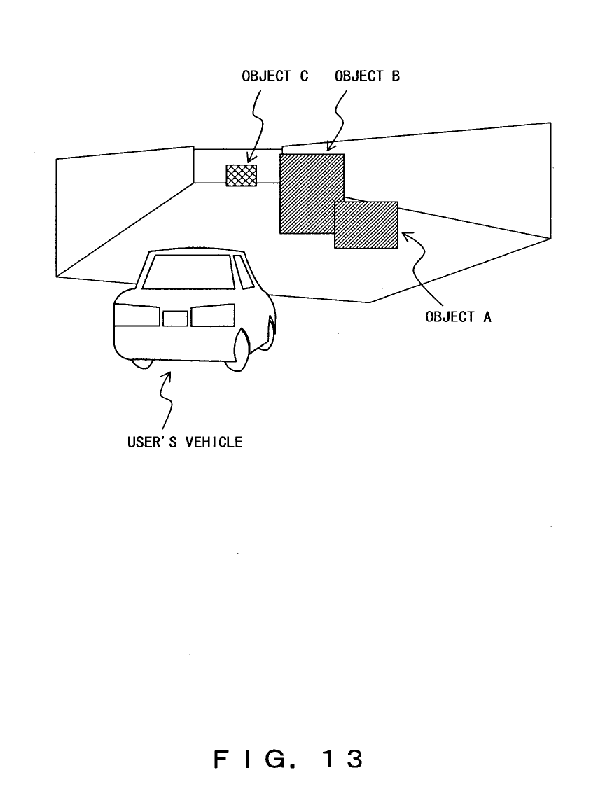

Here, the case where the image generation device 1000 is applied as a system for monitoring the situation around a vehicle is explained by referring to FIG. 4 and FIG. 13.

As previously explained, FIG. 4 shows a situation in a field of view that the driver of a vehicle may experience. The driver can see three vehicles of the vehicle A, the vehicle B and the vehicle C on the road.

On the vehicle, a distance sensor (the distance measurement device 101) for measuring distances to obstacles being around the vehicle, and a plurality of cameras (camera units 107) for acquiring images of the surroundings of the vehicle are mounted. For example, when the position behind and above the driver's vehicle is set as the virtual viewpoint, the viewpoint conversion image data 113 as viewed from the virtual viewpoint is produced by the spatial model generation device 103, the space reconfiguration device 109 and the viewpoint conversion device 112, and the viewpoint conversion image data 113 is stored in the database.

The collision probability calculation device 1015 calculates the probability of the collision between the spatial model 104 and the camera unit arrangement object model 110 which is a model of the corresponding camera unit arrangement object as the driver's vehicle based on one of the viewpoint conversion image data 113 at two points of time, which was produced by the viewpoint conversion device 112, the captured image data 108 expressing the captured image, the spatial model 104 and the spatial data 111 obtained by the mapping. For example, the collision probability calculation device 1015 calculates the probability of the collision between the driver's vehicle and another vehicle in front of the driver's vehicle.

The display device 1014 is generally arranged in a vehicle and displays the image in a different manner in accordance with the probability of the collision calculated by the collision probability calculation device 1015 upon displaying the image viewed from an arbitrary virtual viewpoint in the 3D space based on the viewpoint conversion image data 113 produced by the viewpoint conversion device 112 by sharing a monitor-display device with a car navigation system for example. For example, in the case when there is a plurality of vehicles in front of the driver's vehicle, the vehicles are displayed in different colors or blink at different intervals in accordance with the probability of the collision between the driver's vehicle (user's vehicle) and other vehicles.

FIG. 13 shows an example of displaying the image in a different manner in accordance with the probability of the collisions between two objects.

In FIG. 13, the object A is displayed as the viewpoint conversion image of the vehicle A in FIG. 4, similarly, the object B and the object C are viewpoint conversion images respectively of the vehicle B and the vehicle C. The manner of displaying the objects A, B and C are different in accordance with the probabilities of the collisions between the user's vehicle and the vehicles A, B and C. For example, the object C which is the viewpoint conversion image of the vehicle C with the highest probability of the collision with respect to the user's vehicle among the three vehicles is displayed in red, and the object A, which is the viewpoint conversion image of the vehicle A, and the object B, which is the viewpoint conversion image of the vehicle B, none of which has the probability of the collision so high as that of the vehicle C are displayed in yellow. In the case when the display is conducted in different colors in the respective examples in FIG. 5, FIG. 8 and FIG. 13, it is possible that the display is conducted differently in at least one of the factors of hue, saturation and/or brightness of the color.

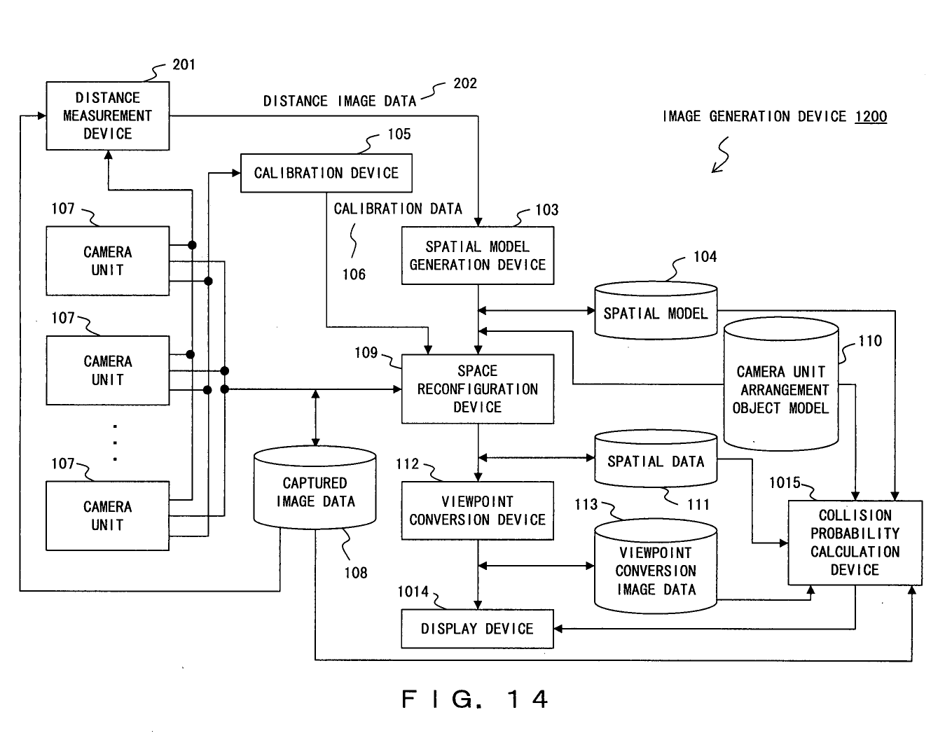

FIG. 14 is a block diagram of the image generation device for generating a spatial model by the camera units and for displaying a viewpoint conversion image in such a manner that the probability of the collision between objects is understood.

In FIG. 14, an image generation device 1200 comprises the distance measurement device 201, the spatial model generation device 103, the calibration device 105, one or a plurality of camera units 107, the space reconfiguration device 109, the viewpoint conversion device 112, the display device 1014 and the relative velocity calculation device 1015.

The image generation device 1200 is different from the image generation device 1000 explained in FIG. 10 only in the point that the image generation device 1200 comprises the distance measurement device 201 in place of the corresponding distance measurement device 101. The explanation of the distance measurement device 201 will be omitted because the distance measurement device 201 is already explained in FIG. 2.

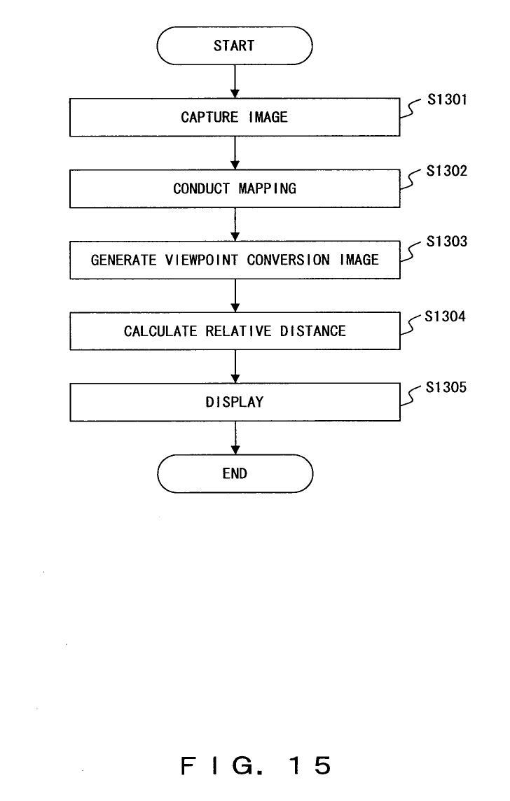

Next, a flow will be explained by referring to FIG. 15 to FIG. 17, which is for an image generation process of displaying in such a manner that the relationship between an object on which a camera is mounted and images acquired by the camera can be understood intuitively when a viewpoint conversion image is displayed.

FIG. 15 is a flowchart for showing a flow of the image generation process of displaying in such a manner that the distance between objects is understood in the viewpoint conversion image.

First, in a step S1301, by using a camera mounted on an object such as a vehicle, images of the surroundings of the vehicle mounting the camera are acquired.

In a step S1302, the captured image data 108 (which is the data of the image acquired in the step S1302) is mapped onto the spatial model 104, and the spatial data 111 is produced.

In a step S1303, the viewpoint conversion image data 113 as viewed from an arbitrary virtual viewpoint in a 3D space is produced based on the spatial data 111 obtained by the mapping in the step S1302.

Next, in a step S1304, a distance between the spatial model 104 and the camera unit arrangement object model 110 which is a model of the corresponding camera unit arrangement object as the driver's vehicle is calculated based on one of the produced viewpoint conversion image data 113, the captured image data 108, the spatial model 104 and the spatial data 111 obtained by the mapping.

Then, in a step S1305, the image is displayed in a manner different in accordance with the distances calculated in the step S1304 upon displaying the image viewed from an arbitrary virtual viewpoint in a 3D space.

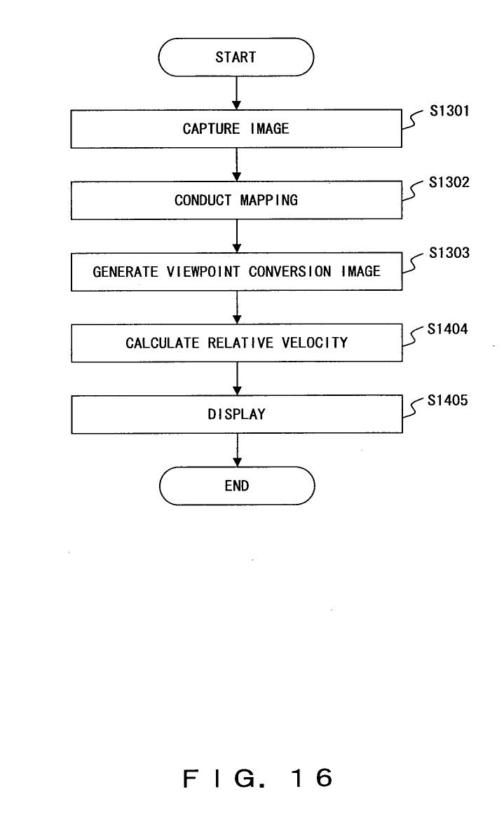

FIG. 16 is a flowchart for showing a flow of an image generation process of displaying in such a manner that the relative velocity between objects is understood.

The step S1301 to the step S1303 are the same as the step S1301 to the step S1303 explained by referring to FIG. 15.

After producing the viewpoint conversion image data 113 in the step S1303, a relative velocity between the spatial model 104 and the camera unit arrangement object model 110 which is a model of the corresponding driver's vehicle is calculated based on one of the produced viewpoint conversion image data 113, the captured image data 108, the spatial model 104 and the spatial data 111 obtained by the mapping in a step S1404.

Then, in a step S1405, objects are displayed in a different manner in accordance with the relative velocity calculated in the step S1404 upon displaying the image viewed from an arbitrary virtual viewpoint in a 3D space.

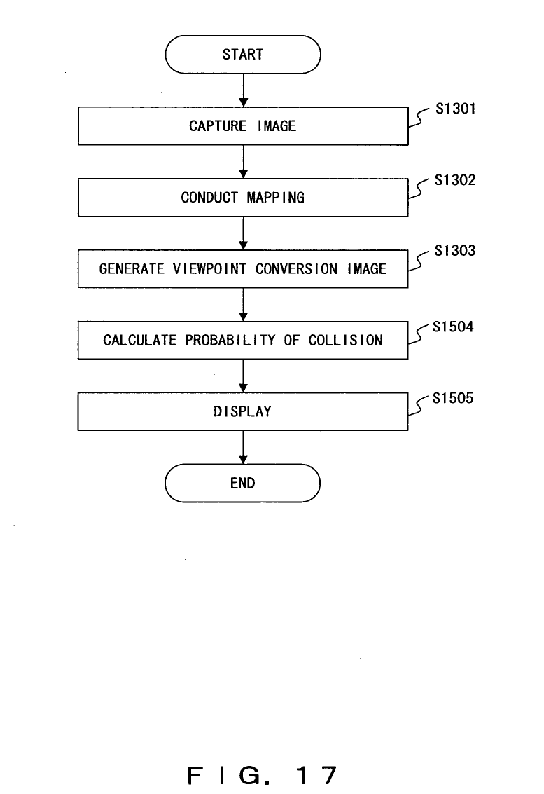

FIG. 17 is a flowchart for showing a flow of an image generation process of displaying in such a manner that the probability of the collision between objects is understood.

The step S1301 to the step S1303 are the same as the step S1301 to the step S1303 explained by referring to FIG. 15.

After producing the viewpoint conversion image data 113 in the step S1303, the possibility of the collision between the spatial model 104 and the camera unit arrangement object model 110 which is a model of the corresponding driver's vehicle is calculated based on one of the produced viewpoint conversion image data 113, the captured image data 108, the spatial model 104 and the spatial data 111 obtained by the mapping in a step S1504.

Then, in a step S1505, objects are displayed in manners different in accordance with the probability of the collision calculated in the step S1504 upon displaying the image viewed from an arbitrary virtual viewpoint in a 3D space.

Additionally, the above first embodiment can be expanded as below.

In the first embodiment which has been described, a vehicle is used as an camera unit arrangement object, and the images acquired by the camera units 107 mounted on the camera unit arrangement object are utilized. However, images acquired by monitoring cameras mounted on a structure facing a road, mounted in a store or the like can also be applied to this configuration in the case where the camera parameters are already known, can be calculated or can be measured. Further, the distance measurement devices 101 and 102 can also be arranged similarly to the cameras, and the distance information (distance image data 202) obtained by these distance measurement devices 101 and 102 arranged on a structure facing a road, arranged in a store or the like can be utilized.

In other words, it is not always necessary that the display device 114, 314, 714 or 1014 be arranged in the same camera unit arrangement object as that in which the camera units 107 are arranged, and the present invention can be applied to all the situations that include an obstacle that travels relatively.

Further, the configuration is also possible in which a plurality of image generation devices 100, 200, 300, 600, 700, 900, 1000 and 1200 (the configuration by a plurality of the same type of the image generation devices is possible, and the configuration by a plurality of the different types of image generation devices is also possible. For example, the configuration by a plurality of the image generation devices 100 is possible, and the configuration by the image generation devices 100 and the image generation devices 200 is also possible) transmit and receive data to/from one another.

In the above cases, the respective data and models in the first embodiment is transmitted and received among the respective image generation devices 100, 200, 300, 600, 700, 900, 1000 and 1200 by a communication device comprising a coordinate transformation device for conducting a coordinate transformation in accordance with the manners for utilizing the respective viewpoints, and a coordinate orientation calculation unit for calculating the reference coordinate is provided.

The coordinate orientation calculation unit is a device for calculating a position/orientation at which the viewpoint conversion image is generated. Regarding this, data such as the latitude, longitude, altitude and direction acquired by the GPS (Global Positioning System) for example can be used for setting the coordinate of the virtual viewpoint. Alternatively, it is also possible that the coordinate transformation is conducted and a predetermined virtual viewpoint conversion image is generated by obtaining the relative position coordinate in the corresponding image generation devices 100, 200, 300, 600, 900, 1000 and 1200 by calculating the relative position coordinate with respect to other image generation devices 100, 200, 300, 600, 700, 900, 1000 and 1200. This corresponds to setting the desired virtual viewpoint in these coordinate systems.

### Second Embodiment

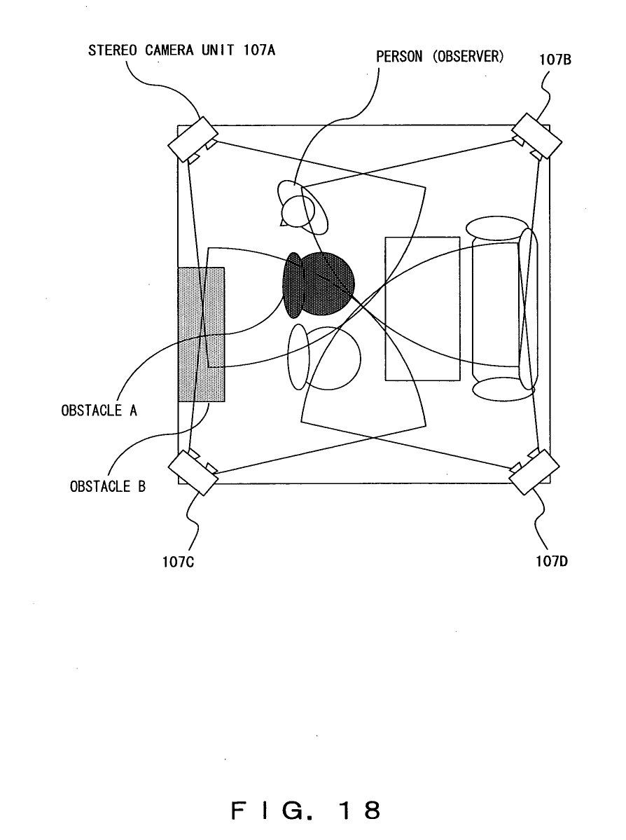

FIG. 18 explains a second embodiment in which the present invention is applied to indoor monitoring cameras.

FIG. 18 shows a room as a monitored target as viewed from above (i.e. the ceiling). Four stereo camera units 107A, 107B, 107C and 107D, which are monitoring cameras, are arranged in arbitrary places in the room for acquiring images in the room.

For example, the stereo camera units 107A, 107B, 107C and 107D may be arranged at the four corners of the center of the ceiling of the room, alternatively, it is also possible that ultra wide angle cameras in the vicinity of the ceiling. Further, these stereo camera units 107A, 107B, 107C and 107D can be stereo cameras each having a combination of binocular, trinocular or further configuration. Naturally, in place of these stereo cameras, the measurement devices 101 and 201 (for example, a laser radar, a slit scan measurement device, an ultra radio wave sensor, a model of a room made by the CAD) can be used together. The images acquired by the image generation devices 107A, 107B, 107C and 107D are mapped onto the spatial model which is configured by the above components, the arbitrarily desired virtual viewpoint is set, and the viewpoint conversion image is generated.

Additionally, it is possible that in stead of the above distance, relative velocity or probability of collision with respect to the camera unit arrangement object, the distance, the relative velocity and the probability of collision between two objects in the viewpoint conversion image are calculated and the objects are displayed in such a manner that these distance, relative velocity and the probability of collision can be understood. For example, it is possible that the camera unit 107 is arranged in a room or on a street, calculates the distance, the relative velocity and the probability of collision between a person walking in a room/on a street and things in/outside a room or between a person walking in a room/on a street and other traveling objects (vehicle, or robot) are displayed in such a manner that the calculated distance, relative velocity and the probability of collision are recognized.

Additionally, it is also possible that a person who is an observer wears a device such as a HMD (Head Mounted Display) for example, and observes the viewpoint conversion image, and the position, the orientation, the direction of the observer himself/herself is measured by the cameras on the camera unit arrangement object. It is also possible that the coordinate orientation information measured by the GPS, a gyro sensor, a camera device and a sight line detection device for a human being, worn by the person who is the observer, are used together.

By setting the virtual viewpoint to the viewpoint of the observer, the distance, the relative velocity and the probability of the collision with respect to the observer can be calculated. Thereby, the observer can find obstacles for him/her on the virtual viewpoint image displayed on the HMD or the like, and the danger for the observer such as a suspicious person, a dog or a vehicle behind him/her can be recognized. Further, even an object that is far from the observer can be recognized via the multi-viewpoint conversion image generated accurately by using the camera unit arrangement object close to the object, images and the spatial model of the image generation device.

Naturally, the present invention can be applied to the case where the traveling object is a vehicle or the like in place of a person.

It is also possible in the above respective embodiments that a plurality of camera units constitutes a so-called trinocular stereo camera, quadocular stereo camera. It is known that when the trinocular stereo camera or the quadocular stereo camera is employed, process results that are more reliable and more stable can be obtained in a 3D reconfiguration process (for example, see “HIGH PERFORMANCE 3D VISUAL SYSTEM” fourth issue, vol. 42, Fumiaki TOMITA published by Information Processing Society of Japan). Especially, it is known that by arranging a plurality of cameras in such a manner that the arranged cameras have a two-directional baseline length, the 3D reconfiguration in a more complex scene is realized. Further, when a plurality of cameras is arranged in a direction of the baseline length, a stereo camera that is based on a so-called multi-baseline method can be realized so that a more accurate stereo measurement is realized.

The respective embodiments of the present invention have been explained by referring to the drawings as above. However, it is needless to say that the image generation device to which the present invention is applied is not limited to the above respective embodiments as long as the functions of the image generation device are realized, and the image generation device can be a stand-alone unit, can be a system configured by a plurality of devices, can be an unitary device or can be a system whose process are executed via a network such as a LAN, WAN or the like.

Additionally, the image generation device according to the present invention can be realized by a system configured by a CPU, memory such as a ROM or a RAM, an input device, an output device, an external storage device, a media driving device, a transportable storage medium, a network connection device which are connected to a bus. In other words, it is needless to say that the image generation device according to the present invention can be realized by a configuration in which memory such as a ROM or a RAM, an external storage device or a transportable storage medium storing program code as software for realizing the systems in the above respective embodiments is provided to the image generation device, and the computer for the image generation device reads the program code and executes the program.

In the above case, the program code itself read from the transportable storage medium or the like realizes the novel functions of the present invention, and the transportable storage medium or the like storing the program code is one of the components which constitute the present invention.

As the transportable storage medium for providing the program code, various storage media or the like can be used that store the program code via a floppy disk, a hard disk, an optical disk, a magneto-optical disk, a CD-ROM, a CD-R, a DVD-ROM, a DVD-RAM, a magnetic tape, a non-volatile memory card, a ROM card, a connection device (or a communication circuit) such as an E-mail system or a personal computer communication system or the like.

Additionally, using the computer executing the program code read to the memory, the functions in the above respective embodiments are realized, and further, a part or a whole of the actual processes are executed by the OS on the computer based on the instructions by the read program code, so that the functions in the above respective embodiments are realized also by these processes.

Further, it is possible that after the program code read from the transportable storage medium or the program (data) provided by a program (data) provider is written to memory included in a function extension board inserted into the computer or in a function extension unit connected to the computer, the CPU included in the corresponding function extension board or in the function extension unit executes a part or a whole of the actual processes based on the instructions by the program code so that the functions in the above respective embodiments are realized also by the executed processes.

In other words, the present invention is not limited to the above respective embodiment, and can employ various configurations or various forms without departing from the spirit of the present invention.

According to the present invention, a synthesized image is generated which causes a feeling as if really viewing from a virtual viewpoint based on a plurality of images acquired by one or a plurality of cameras mounted on an image acquisition means arrangement object such as a vehicle or the like, and the synthesized image can be displayed in such a manner that the relationship between the above image acquisition means arrangement object and the captured images are intuitively understood.

### Third Embodiment

In a third embodiment of the present invention, a blind spot for a driver is detected and a viewpoint is set for observing the detected blind spot in order that the driver can see the virtual viewpoint image viewed from such a viewpoint. Alternatively, from the above detected blind spot, the blind spot which has to be displayed is selected based on driving operation information, operations by the driver or the like, the viewpoint for observing the selected blind spot is set, and the virtual viewpoint image viewed from the set viewpoint is displayed for the driver. Hereinbelow, the third embodiment of the present invention will be explained sequentially and specifically by referring to the drawings.

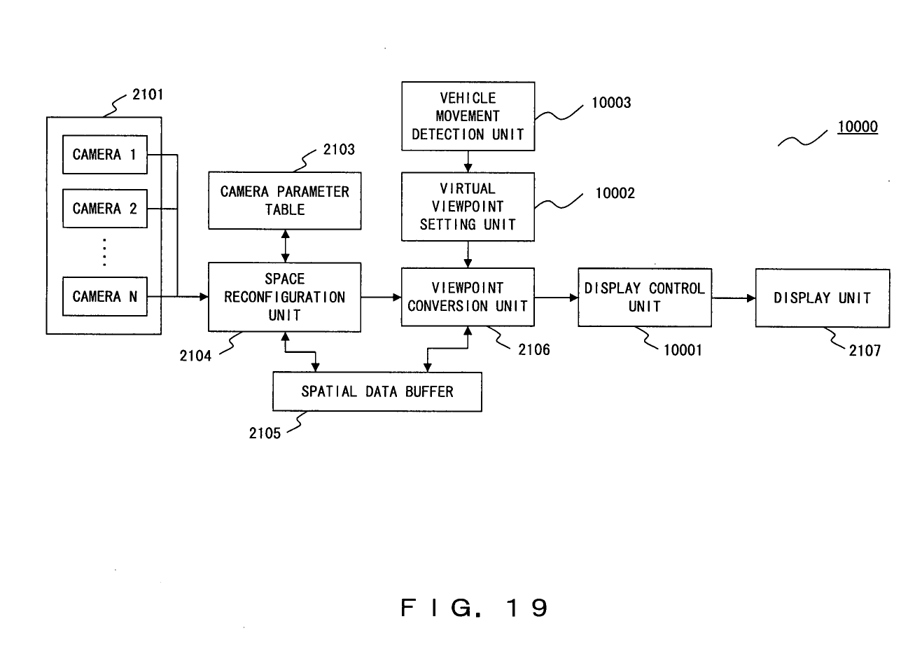

FIG. 19 shows an image generation device 10000 according to the third embodiment of the present invention.

In FIG. 19, the image generation device 10000 comprises one or a plurality of cameras 2101, a camera parameter table 2103, a space reconfiguration unit 2104, a spatial data buffer 2105, a viewpoint conversion unit 2106, a display unit 2107, a display control unit 10001, a virtual viewpoint-setting unit 10002 and vehicle movement detection units 10003.

The plurality of cameras 2101 are arranged in such a manner that they are adapted to recognize the situation of the area as the monitored target. The cameras 2101 are the plurality of cameras that captured images of the space to be monitored such as the situation around the vehicle or the like for example. It is usually advantageous that each camera 2101 is the camera with a large angle of view in order to secure a wide field of view. Regarding the number of the cameras 2101 and the arrangement manner of these cameras 2101 and the like, the known way such as disclosed in the Patent Document 1 can be employed for example. Additionally, a plurality of cameras are used in the example of the figure, however, it is possible to acquire, by sequentially changing the arrangement position of one camera, image acquisition data which is equivalent to that in the case where a plurality of cameras are provided. This point is applied to the examples explained below.

In the camera parameter table 2103, the parameters specifying the characteristics of the camera 2101 are stored. Here, the camera parameters are explained. In the image generation device 10000, a calibration unit (not shown) is provided for conducting calibration. The camera calibration is to determine and to correct camera parameters specifying the characteristics of the camera 2101 in a 3D world, such as the position at which the camera is mounted, the angle at which the camera is mounted, the correction value for lens distortion of the camera, the focal length of the camera and the like regarding the camera arranged 3D in a 3D world. This calibration unit and the camera table 2103 are explained in detail also in the Patent Document 1 for example.

In the space reconfiguration unit 2104, the spatial data is produced by mapping the images input by the camera 2101 onto a spatial model in a 3D space. In other words, the space reconfiguration unit 2104 produces the spatial data in which the respective pixels constituting the images input from the cameras 2101 are association with points in a 3D space, based on the camera parameters calculated by the calibration unit (not shown).

Specifically, in the space reconfiguration unit 2104, the positions in the 3D space of the respective objects included in the images acquired by the cameras 2101 are calculated, and the spatial data as the result of the above calculation is stored in the spatial data buffer 2105. Additionally, the spatial model can be a predetermined (prescribed) model, can be a model produced each time based on a plurality of input images, or can be a model produced based on outputs from a sensor provided separately.

For example, as described in the Patent Document 1, the spatial model can be a spatial model constituted by five planes, a bowl shaped spatial model, a spatial model constituted by combining planes and curved planes, a spatial model which utilizes a screen or a spatial model constituted by combining these features. Additionally, the form of the spatial model is not limited to those of the above spatial models as long as the spatial model employs the configuration of the combination of the planes, the configuration of the combination of the curved planes, or the configuration of the combination of the planes and the curved planes. Further, the spatial model can be generated based on a stereo image obtained by a stereo sensor or the like for acquiring a distance image to be used for calculating the distance image by the triangulation (for example Japanese Patent Application Publication No. 05-265547, and Japanese Patent Application Publication No. 06-266828).

Additionally, it is not necessary to configure the spatial data by using all the pixels constituting the images input from the cameras 2101. For example, in the case where there are areas which are above the horizontal line in the input image, it is not necessary to map the pixels in the areas above the horizontal line onto the road. It is not necessary to map pixels constituting a vehicle either. Additionally, in the case where the input images are of high resolution, it is also possible that the processing speed is increased by mapping the pixels while skipping a pixel for the predetermined number of the pixels. This space reconfiguration unit 2104 is explained in detail in the Patent Document 1 for example.

In the data buffer 2105, the spatial data produced by the space reconfiguration unit 2104 is temporarily stored. This spatial data buffer 2105 is also explained in detail in the Patent Document 1 for example.

In the viewpoint conversion unit 2106, referring to the spatial data generates an image viewed from an arbitrary viewpoint. In other words, referring to the spatial data produced by the space reconfiguration unit 2104 generates the image equivalent to the image acquired by a camera arranged at an arbitrary point. Also regarding this viewpoint conversion unit 2106, the configuration disclosed in detail in the Patent Document 1 can be employed for example.

The vehicle movement detection units 10003 detect the movement of the vehicle. For example, the vehicle movement detection units 10003 detect whether the vehicle is turning to the right or the vehicle is turning to the left based on the steering angle of the steering wheel, or detects whether or not the brakes are applied. In order to detect the movement of the vehicle as above, the vehicle is provided with sensors and measurement instruments at various spots on the vehicle.

The virtual viewpoint setting unit 10002 sets the parameters regarding the virtual viewpoint to be transmitted to the viewpoint conversion unit 2106. The virtual viewpoint-setting unit 10002 can set these parameters in accordance with the movement of the vehicle detected by the vehicle movement detection units 10003.

The display control unit 10001 controls the manner of display of the virtual viewpoint image generated by the viewpoint conversion unit 2106, which display is conducted by the display unit 2107 (for example, a display device or the like).

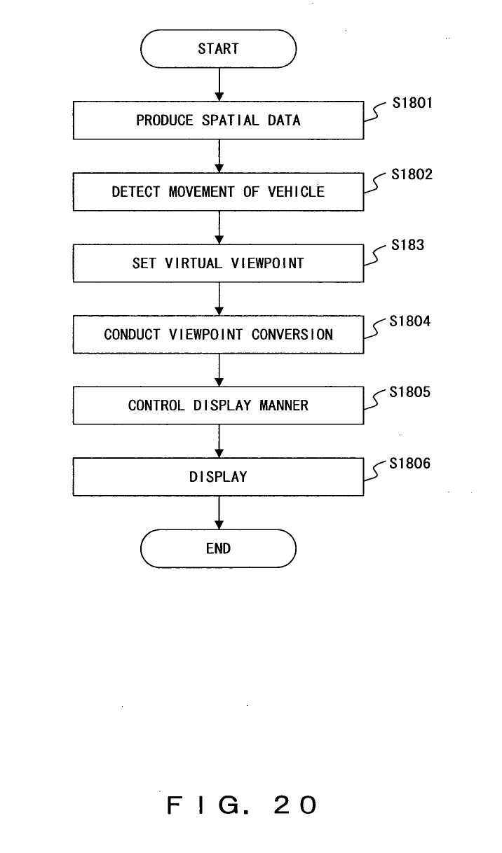

FIG. 20 shows a flow of the display process of the virtual viewpoint image in the third embodiment of the present invention.

First, in the space reconfiguration unit 2104, the relationship between the respective pixels constituting the images acquired by the cameras 2101 and the points on the 3D coordinate system is calculated, and the spatial data is produced (S1801). This calculation is conducted on all the pixels in the images acquired by the respective cameras 2101. For this process, the manner disclosed in the Patent Document 1 for example can be employed.

Next, as described above, after the movement of the vehicle is detected by the vehicle movement detection units 10003 such as various sensors and the like (S1802), the virtual viewpoint setting unit 10002 sets the virtual viewpoint in accordance with the movement of the vehicle detected by the vehicle movement detection units 10003 (S1803).

Next, the viewpoint conversion unit 2106 reproduces the image viewed from the viewpoint specified in the S1803 from the above spatial data (S1804). For this process, the known manner that is also disclosed in the Patent Document 1 can be employed. Thereafter, the display control unit 10001 controls the manner of display of the reproduced image (S1805). The process in the step S1805 will be explained in detail. Thereafter, the image for which the display manner is controlled is output to the display unit 2107, and the display unit 2107 displays the image (S1806).

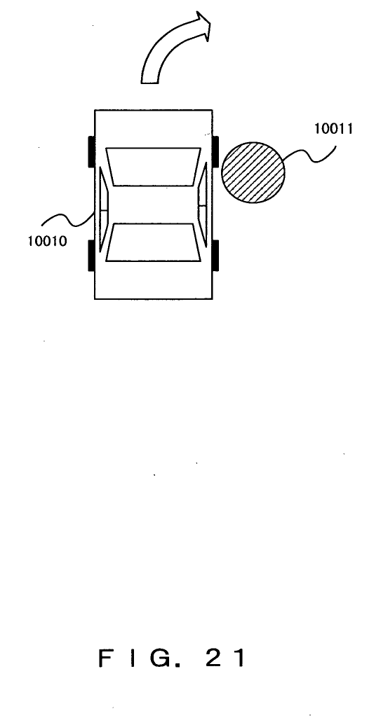

FIG. 21 shows an example of detecting the blind spot for the driver based on the driving operations by the driver in the third embodiment of the present invention.

FIG. 21 shows a blind spot 10011 that is detected when a vehicle 10010 is turning to the right. When the vehicle 10010 is turning to the right, the spot around the front right wheel has to be observed in order to avoid the accident in which the rear right wheel or the portion around it hits an object because when a vehicle is turning, the inner rear wheel runs on a different course from that of the inner front wheel.

However, in this case, the spot between the courses of the front right wheel and the rear right wheel becomes the blind spot because the driver cannot see that spot with the front right door, the hood and the instrument panel blocking the driver's sight. Also, this spot becomes the blind spot even when the side mirror is used. Accordingly, in the third embodiment in the present invention, the spot which can become the blind spot such as this is detected based on the driving operations by the driver.

In the case of FIG. 21, the driver turns the steering wheel and the vehicle turns to the right (or to the left). This movement of turning to the right (or to the left) is detected by the vehicle movement detection units 10003 (S1802 in FIG. 20). Upon this, the vehicle movement detection units 10003 detect the degree of the turn of the steering wheel i.e., whether the direction of the turn is in a clockwise direction or in a counter clockwise direction, the angle, the velocity and the acceleration of the vehicle making the turn is detected. The information obtained by the detection is transmitted to the virtual viewpoint-setting unit 10002. The virtual viewpoint-setting unit 10002 recognizes the driving operations by the driver and specifies the blind spot 10011 for the driver based on the information obtained by the detection.

Additionally, the position of the viewpoint of the driver is obtained in advance. For example, it is possible that the image of the driver's face is acquired by the camera for monitoring inside the vehicle, and the positions of the eyeballs are obtained from the image of the driver's face using a conventional image processing technique for obtaining the positions of the viewpoint of the driver. It is also possible that the driver's viewpoint is calculated by estimating the posture or the like of the driver.

For example, the position of the viewpoint can be determined approximately because the position of the head of the driver can be measured based on the height (or seated height) of the driver and the current reclining angle of the driver's seat, which are registered in advance. Alternatively, it is also possible that because the position of the viewpoint of a person driving an automobile has the upper limit (the height of the roof), a prescribed value (average value or statistical value or the like) may be set as a default value when it is assumed that there is not a great difference of the position of the viewpoint among persons. Thereby, the virtual viewpoint is obtained.

Then, by utilizing data by the CAD (Computer Aided Design), i.e., based on the CAD data regarding the obtained position of the viewpoint of the driver and the vehicle, the blind spot with respect to the viewpoint of the driver is obtained, and the information of the blind spot and the above obtained virtual viewpoint information (including the information of the direction) are transmitted to the viewpoint conversion unit 2106.

The viewpoint conversion unit 2106 generates the virtual viewpoint image viewed from the virtual viewpoint (S1804 of FIG. 20) based on the received information. Upon this, the virtual viewpoint image including the blind spot and the area around the blind spot is generated. (Depending upon the purpose, it is possible that only the virtual viewpoint image including the blind spot is generated.)

The above virtual viewpoint image includes the blind spot and the area around the blind spot, and this image is displayed in such a manner that the blind spot and the area around the blind spot can be distinguished from each other. For example, it is possible that the blind spot and the area around the blind spot are displayed in different colors, or that the blind spot are displayed with emphasis.

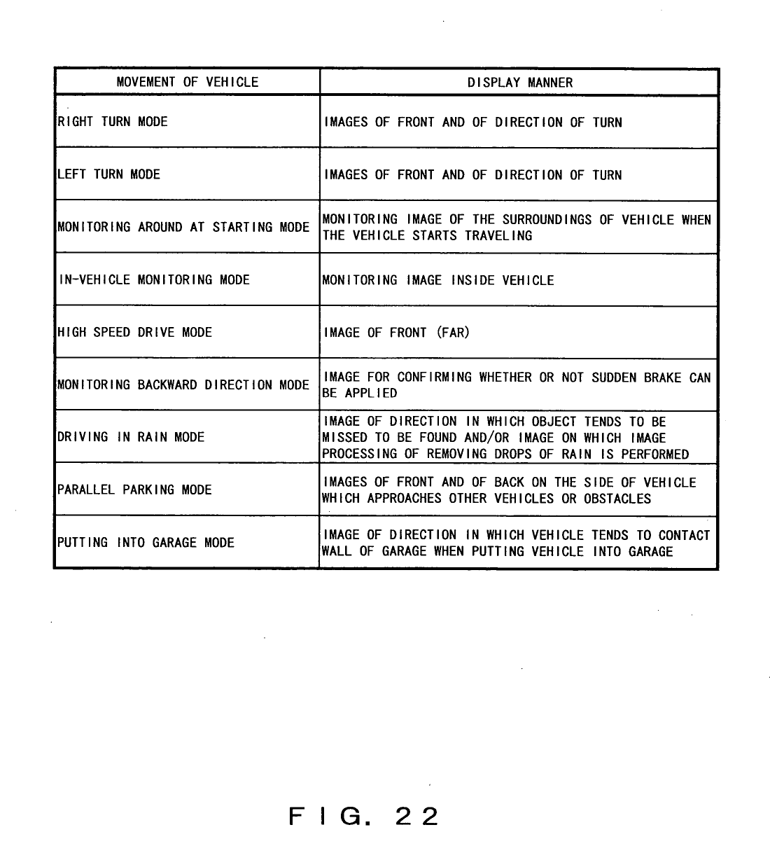

Further, it is also possible that the manners of display of the image of the blind spot to be displayed based on the blind spot information detected by the vehicle movement detection unit are switched. Specifically, the information is obtained, regarding the occurrence trend of the blind spot that is variable, in accordance with the detected information, and a virtual viewpoint in a 3D space is adaptively set such that the virtual viewpoint is suitable for the occurrence trend of the corresponding blind spot. For example, it is possible that the preset modes such as the right turn mode, the left turn mode and the like are switched to be applied in accordance with the above detected blind spot information as shown in FIG. 22.

FIG. 22 shows an example of the modes of the movements of the vehicle in the third embodiment of the present invention.

As the modes of the movement in the third embodiment of the present invention, there are a “Right turn mode”, a “Left turn mode”, a “Monitoring around at starting mode”, an “In-vehicle monitoring mode”, a “High speed drive mode”, a “Monitoring backward direction mode”, a “Driving in rain mode”, a “Parallel parking mode” and a “Putting into garage mode”. These modes will be explained below.

In the “Right turn mode”, images of the front and of the direction in which the vehicle is turning are displayed. Specifically, when the vehicle is turning to the right, the image of the front and the image of the right are displayed. In the “Left turnmode”, images of the front and the image of the direction in which the vehicle is turning are displayed. Specifically, when the vehicle is turning to the left, the image of the front and the image of the left are displayed.

In the “Monitoring around at starting mode”, the monitoring image regarding the surroundings of the vehicle when the vehicle starts traveling is displayed. In the “In-vehicle monitoring mode”, the image inside the vehicle is displayed. In the “High-speed drive mode”, the image toward a far front is displayed while the vehicle is traveling at a high-speed. In the “Monitoring backward direction mode”, the image of the back is displayed for confirming whether or not a sudden brake can be applied i.e., whether or not there is the interval between the user's vehicle and the following vehicle which is sufficiently long so as to allow the user's vehicle to stop by the sudden braking.

In the “Driving in rainmode”, because the direction in which an object is missed to be found sometimes occurs due to a worse sight in the rain, the image of the direction such as above in which an object tends to be missed to be found and/or the image on which the image processing of removing drops of rain is performed is displayed. The above direction in which an object tends to be missed to be found may be obtained by the statistics or by the experience, or can be set arbitrarily by the user.

In the “Parallel parking mode”, the images of the front and of the back on the side of the vehicle which approaches other vehicles or obstacles so that the user's vehicle does not contact the front vehicle or the vehicle behind. In the “Putting into garage mode”, the image of the direction in which the vehicle tends to contact a wall of a garage when putting the vehicle into the garage is displayed.

As above, the modes are selected based on the detected movement of the vehicle, and the virtual viewpoint image is displayed in a manner corresponding to the selected mode.

As above, the virtual viewpoint image of the blind spot for the driver can be provided to the driver. Additionally, in FIG. 21, the area between the courses of the front right wheel and the rear right wheel upon turning to the right is obtained as the blind spot, however, the blind spot can be the spot between the courses of the front outer wheel and the rear outer wheel of a vehicle making a turn, the back of the vehicle when driving backward, or can be any kind of the blind spot that can occur during the drive operations.

Additionally, in order to detect these blind spots, various sensors (sensors for detecting infrared rays, a temperature, a humidity, a pressure, an illuminance, mechanical operations and the like), cameras (for acquiring images inside the vehicle or for acquiring images of the vehicle itself) and measurement instruments are mounted on the respective spots of the vehicle. (Alternatively, the measurement instruments with which the vehicle is originally equipped such as a tachometer, a speed meter, a coolant temperature meter, an oil pressure meter, a fuel gauge and the like may be used.)

Additionally, as a method for acquiring information specifying the blind spot, the invention disclosed in the Patent Document 1 for example may be used in addition to the above methods. Specifically, the blind spot for a driver is obtained by subtracting the virtual viewpoint image by the virtual viewpoint from the viewpoint of the driver in the driver's seat from the virtual viewpoint image by the virtual viewpoint from the spot above the vehicle.

Additionally, in the third embodiment of the present invention, the example of the blind spot 10011 in FIG. 21 has been explained, however, other blind spots occur when a vehicle turns to the right. Accordingly, in the case where there are a plurality of blind spots when the vehicle performs a prescribed movement, it is possible to select one of the blind spots to be displayed as the virtual viewpoint image. Further, it is also possible to store the selected information in the storage device in the image generation device as the history information. Thereby, the selection frequency of the user can be obtained from this history information, accordingly, it is possible to automatically display the virtual viewpoint image of the blind spot which is selected the most frequently based on the selection frequency. It is also possible to set the virtual viewpoint image to be displayed in association with a prescribed movement of the vehicle in advance.

Thereby, the virtual viewpoint image of the area that becomes the blind spot can be displayed in association with the movement of the vehicle; accordingly, the driver can drive the vehicle safely while confirming the area that is currently the blind spot when the vehicle is performing the movement associated with the blind spot. Additionally, as is understood from the above description, in the present application, the “blind spot” is, on one hand, the area which the driver can not see no matter what he/she does (no matter whether he or she turns his/her head or uses the mirrors and the like), and on the other hand, the “blind spot” is, limitedly, the area which is obtained (set) as “so-called the blind spot” in accordance with the situation or which is extracted (selected) from the above plurality of the “blind spots” in accordance with the driving situation.

### Fourth Embodiment

In a fourth embodiment of the present invention, when there is a part which blocks the driver's sight and causes the blind spot, the virtual viewpoint image of the view which is equivalent to the image of the view without the blocking part is displayed on a display device arranged on the surface of the blocking part. Therefor, in the fourth embodiment of the present invention, the image display device is arranged in a suitable position so that the display that allows the intuitive understanding is realized.

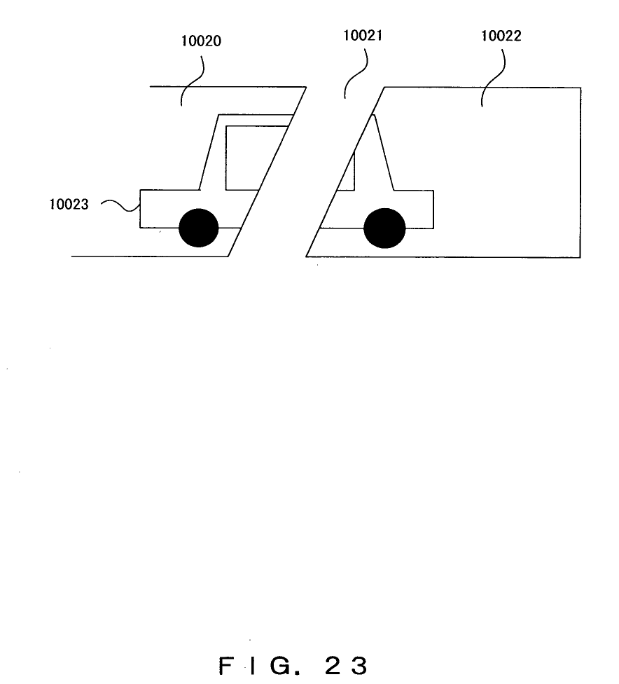

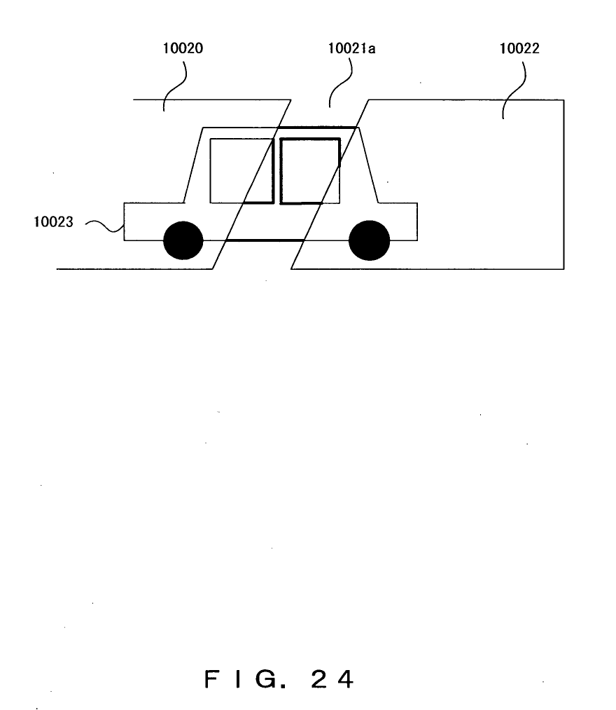

FIG. 23 and FIG. 24 are used for explaining the examples regarding the image generation device in the fourth embodiment of the present invention, and respectively show the situation where the driver sees another vehicle 10023 which is outside the driver's vehicle from the vehicle (driver's seat) over a front pillar 10021 (the pillar is a post positioned between a door and a roof for reinforcement of the vehicle, and is the pillar 10021 between a front glass 10020 and a side window 10022).

FIG. 23 shows the case where the image generation device according to the fourth embodiment of the present invention is not used, in which the driver can not see a part of the body of the vehicle 10023 because the front pillar 10021 blocks the driver's sight (in other words, the pillar causes the blind spot).

FIG. 24 shows the case where the image generation device according to the fourth embodiment of the present invention, in which an image is displayed on the surface of a front pillar 10021a. (For example, a flat panel display such as a liquid crystal display, a plasma display, an organic EL display or the like, an electronic paper display or the like is arranged on the front pillar 10021.)

Thereby, the image can be displayed on the front pillar 10021a. In the fourth embodiment of the present invention, the outside view which the driver could not see without the present invention with the front pillar 10021a blocking the driver's sight (or causing the blind spot) is displayed in the virtual viewpoint image. In FIG. 24, the portion of the vehicle 10023 which the driver cannot see with the blocking part is displayed on the front pillar 10021 in the virtual viewpoint image.

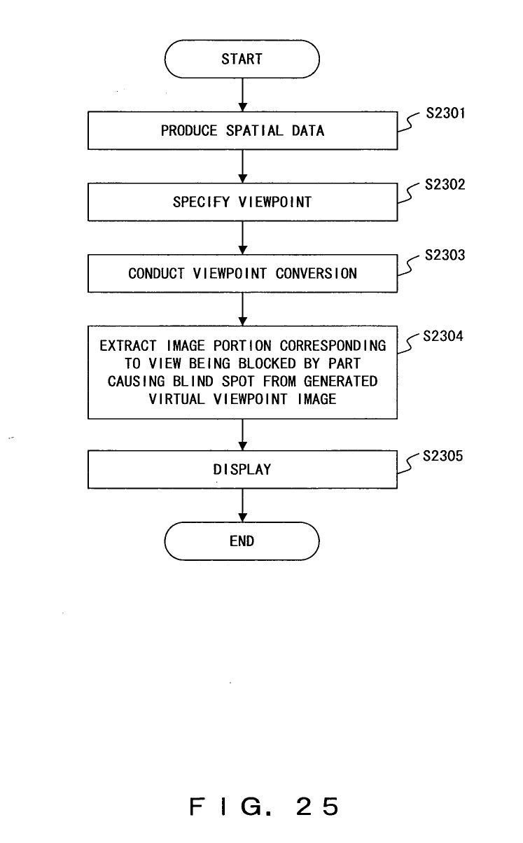

FIG. 25 is a flowchart for showing a flow of displaying the virtual viewpoint image according to the fourth embodiment of the present invention.

First, in the space reconfiguration unit 2104, the relationship between the respective pixels constituting the images acquired by the cameras 2101 and the points on the 3D coordinate system is calculated, and the spatial data is produced (S2301). This process is the same as that in the step S1801 in FIG. 20.

Next, the virtual viewpoint is specified for generating the virtual viewpoint image (S2302). The virtual viewpoint is the viewpoint toward the respective parts in the vehicle which cause the blind spots with respect to the viewpoint of the driver. These viewpoints may be set as fixed values in advance or may be set each time the driver drives the vehicle.

Next, the viewpoint conversion unit 2106 generates the virtual viewpoint image viewed from the viewpoint specified in the S2302 (S2303). This process is the same as that in the S1804 in FIG. 20. Upon this, the virtual viewpoint image of the view without the information regarding the corresponding vehicle is generated.

Next, the display control unit 10001 extracts the image portion corresponding to the view being blocked by the part causing the blind spot extracted from the virtual viewpoint image generated in the step S2303 (S2304). In the example of FIG. 24, only the image of the portion to be displayed on the front pillar 10021a is extracted from the generated virtual viewpoint image. Upon this, the dimensions, the position, the shape and the like of the blocking part which is used as the display unit are registered in the storage device in the image generation device 10000 in advance, accordingly, the image of the portion to be displayed is extracted from the virtual viewpoint image based on the above information.

Additionally, in the step S2304, another process is possible in addition to the above extraction process. For example, the difference is calculated between the virtual viewpoint image generated without taking information of the driver's vehicle into consideration (i.e., the virtual viewpoint image generated without taking any parameter of the user's vehicle into consideration) and the virtual viewpoint image generated by taking the information of the driver's vehicle into consideration, and thereby the blind spot can be obtained. Accordingly, area corresponding to the above calculated difference is displayed by the display unit.

Next, the display unit 2107 displays the extracted image. In the example of FIG. 24, the extracted image is displayed on the front pillar 10021a (S2305).

Thereby, on the part which causes the blind spot, the view over the blocking part which is blocked is displayed on the blocking part, accordingly, the blocking part looks as if it were made of a transparent material. Additionally, the front pillar is used as the part causing the blind spot in the above as an example, however, the present invention is not limited to this embodiment, and the display device (such as a liquid crystal display, a plasma display, an organic EL display, an electronic paper or the like for example) may be arranged on any part (any part that can cause the blind spot for the driver) in the vehicle such as a headrest, an instrument panel, a seat and the like.

### Fifth Embodiment

In a fifth embodiment of the present invention, the display unit has functions of a rear view mirror, and the display unit displays the virtual viewpoint image corresponding to an image which should be on the mirror if the view is reflected by the above mirror. Upon this, similarly to the fourth embodiment, this display unit displays, on the blocking part, the view that is over the blocking part. Thereby, the display that allows the intuitive understanding is realized by arranging the image display device in a suitable position.

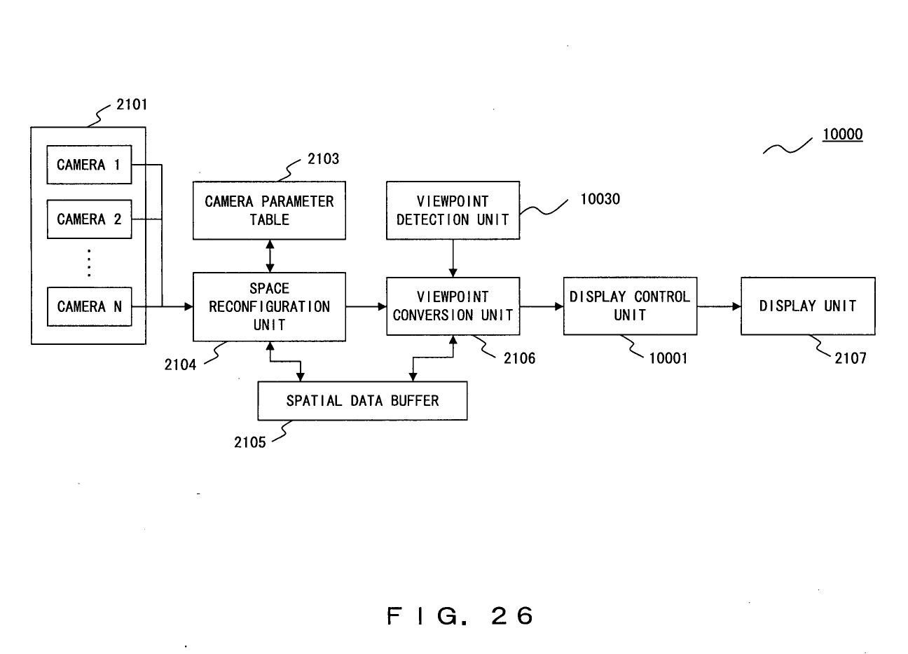

FIG. 26 shows the image generation device 10000 according to the fifth embodiment of the present invention.

In FIG. 26, the image generation device 10000 comprises a plurality of cameras 2101, the camera parameter table 2103, the space reconfiguration unit 2104, the spatial data buffer 2105, the viewpoint conversion unit 2106, the display unit 2107, the display control unit 10001 and a viewpoint detection unit 10030. This configuration is the same as that in the FIG. 19 except for the viewpoint detection unit 10030.

As described above, in the fifth embodiment of the present invention, the display unit 2107 can be used as if it were a mirror. In other words, the display unit having the function of the mirror has to display the image which looks like an image reflected by the mirror for a driver when the driver looks at the display unit.

Accordingly, the relative position of the viewpoint of the driver with respect to the position in which the display unit 2107 is arranged has to be determined. Therefore, in the fifth embodiment of the present invention, in order to detect the position of the viewpoint of the driver with respect to the position in which the display unit 2107 is arranged, the viewpoint detection unit 10030 is used. The viewpoint detection unit 10030 acquires, similarly to the third embodiment, the image of the driver's face by the camera for monitoring inside the vehicle, and the positions of the eyeballs are obtained from the image of the driver's face using a conventional image processing technique for obtaining the positions of the viewpoint of the driver. It is also possible that the driver's viewpoint is calculated by estimating the posture or the like of the driver. Further, it is also possible that the position of the virtual viewpoint is set in advance.

Thereby, the positions of the driver's viewpoints and direction of the slight line can be detected. Also, the arrangement angle or the like of the display unit 2107 with respect to the vehicle is set in advance. Accordingly, the angle of incident of the sight line of the driver on the display surface of the display unit 2107 is calculated when the driver looks at the display unit 2107 based in the above information, and as a result of this, the angle of reflection is obtained.

Then, the display 2107 displays the virtual viewpoint image of the view in the direction with the above obtained angle of reflection. Upon this, the generated virtual viewpoint image is the image generated without taking the information of the vehicle (things in the vehicle, a seat, front pillars, rear pillars or the like) into consideration and, when the image is displayed on the display device, the image is reversed laterally.

Upon this, it is possible that the virtual viewpoint image of the view in the blind spot which could not be seen by the driver without the present invention may be displayed in a wire frame mode, may be displayed in a different color from that of the image of the other portions, or may be displayed with emphasis such that the virtual viewpoint image of the view in the blind spot which could not be seen by the driver without the present invention can be distinguished from the virtual viewpoint image of the view outside the blind spot that can originally be seen.

Upon distinguishing the virtual viewpoint image of the view in the blind spot which could not be seen by the driver without the present invention and that of the view outside the blind spot which can be originally be seen as above, the CAD data is used similarly to the third embodiment. Specifically, the information regarding the blind spot with respect to the driver is obtained and the portion corresponding to the blind spot is displayed in a wire frame mode for example.

Additionally, as a method without the CAD data, it is possible that the virtual viewpoint image generated without taking the information regarding the driver's vehicle into consideration and the virtual viewpoint image generated taking the information regarding the driver's vehicle into consideration are calculated, and the blind spot is obtained by obtaining the difference between these two virtual viewpoint images. Then, based on this information regarding the blind spot, the portion corresponding to the view in the blind spot which could not be seen without the present invention is displayed in a wire frame mode or the like for example.

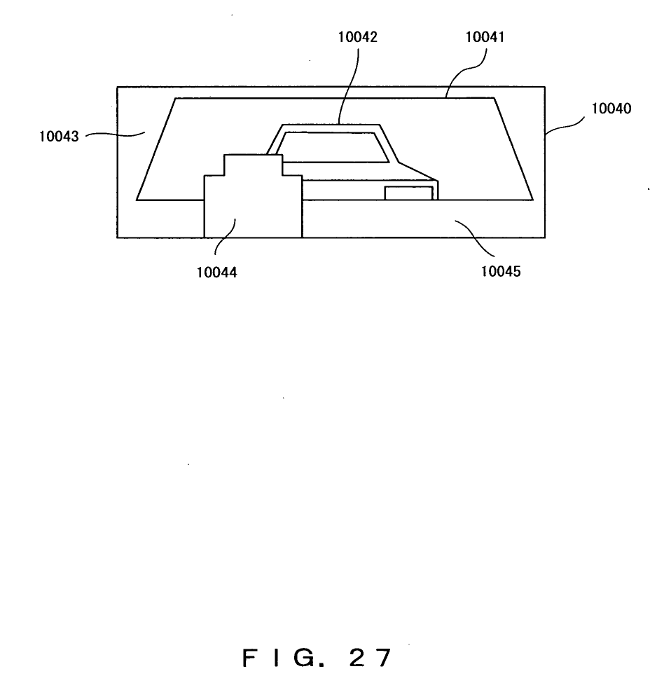

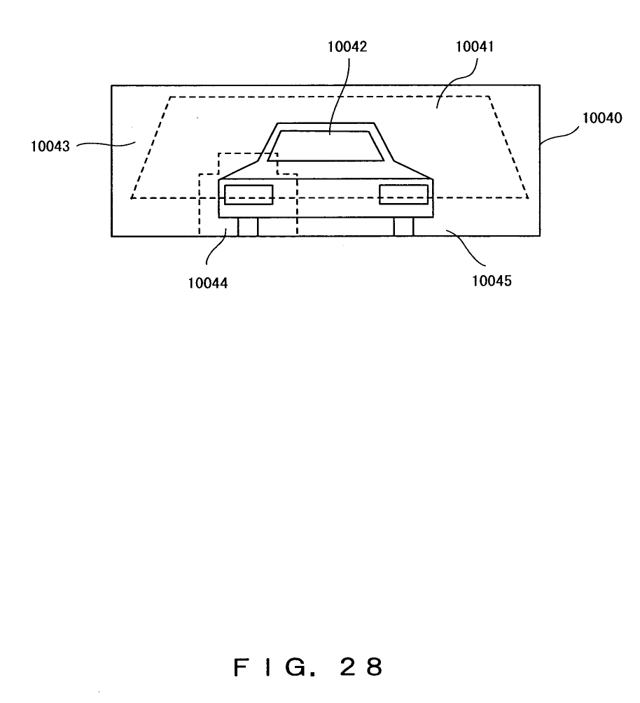

Additionally, as the image that is displayed on the display unit, virtual viewpoint images without the blocking parts such that the blocking part looks as if it were made of a transparent material is displayed. Specifically, the display units arranged on the parts in the vehicle which can cause the blind spots for the driver displays the above virtual viewpoint images corresponding to the views in the blind spots which can not bee seen. The example of this configuration is shown in FIG. 27 and FIG. 28.

FIG. 27 and FIG. 28 show display manners of the images that are displayed on the display unit according to the fifth embodiment of the present invention.

FIG. 27 shows the view (a following vehicle 10042) in a direction of a rear window 10041 displayed in conventional rear view mirror 10040. In the image reflected by the conventional rear view mirror 10040, as shown in FIG. 27 because there are a passenger's seat 10044, a back seat 10045 and a rear window frame 10043 and they cause the blind spots for the driver seeing the rear view by using the rear view mirror, the driver can not see the view over these parts causing the blind spots (in the example of FIG. 27, the lower portion and the right front portions of the following vehicle 10042).

FIG. 28 shows the manner in which the view in the direction in which the rear view window is directed is displayed in the display unit 10046 in the same manner as in the conventional rear view mirror, and the virtual viewpoint image corresponding to the view in the blind spot which the driver cannot see is also displayed. In FIG. 28, the display is conducted in which the lower portion and the right front portion of the following vehicle 10042 which can not be seen because of the blind spots caused by the passenger's seat 10044, the back seat 10045 and the rear window frame 10043 in the example of FIG. 27 are added.

Additionally, in order to specify the potion in the blind spot, the image is displayed in such a manner that the view in the blind spot which can not be seen and the other portions can be seen is distinguished. As the above display manner, the view in the blind spot which can not be seen may be displayed in a wire frame mode as shown in FIG. 28, may be displayed in a different color from that of the image of the other portions, or may be displayed with emphasis.

Additionally, the display unit used in the fifth embodiment of the present invention may employ the configuration in which a half mirror is attached to the surface of the display unit such that the display unit can also function as a normal mirror. It is also possible that the image displayed on the display unit is bent such that the image with a wide field of view is displayed. In other words, it is also possible that the display unit has an effect of a convex mirror.

Further, regarding the display unit, it is also possible that the rear view mirror is configured by the half mirror, a flat panel display is arranged on the back of the half mirror, and a superimposed image for navigation which is to be displayed from behind the half mirror is displayed based on the relationship between the half mirror and the position of the viewpoint of the driver which is detected by a viewpoint position detection unit.

It is also possible that the above display unit (for example, the liquid crystal display, the plasma display, the organic EL display, the electronic paper display or the like) is arranged on a part of a side window. Thereby, the virtual viewpoint image of the situation behind the driver's vehicle that is conventionally confirmed by a side mirror can be displayed on the display unit on a part of a side window, so that the driver can confirm the situation behind his/her vehicle.

Further, in the above configuration, the image can be larger than that on in a side mirror, accordingly, the driver can confirm the situation behind his/her vehicle in more detail. Thereby, the side mirrors can be dispensed with so that the parking space can be reduced for example. Further, even when the driver has to drive his/her vehicle with an oncoming vehicle traveling very closely to the driver's vehicle in a narrow road, there is no risk that the side mirror of the driver's vehicle and that of another vehicle hit each other.

Additionally, it is also possible that as shown in FIG. 22, the manner of display in the display unit is switched in accordance with the modes of the movement of the vehicle. Further, it is also possible that the camera has the functions of panning, tilting, zooming and the like so that the camera can follow the change of the viewpoint. In addition it is also possible that the image is displayed with the reduced lateral aspect such that the sight wider in the lateral direction is obtained.

As above, it is possible that the display unit has the same functions as those of a rear view window, and the virtual viewpoint image corresponding to the view that could not be seen without the present invention is displayed. Further, it is also possible that the viewpoint based on which the display is conducted is calculated by the viewpoint detection unit, and a natural image on the mirror (the image reflected by the mirror) including the added image of the portion in the blind spot is displayed on this display unit.

Additionally, by displaying the outline of the portion which could not be seen being in the blind spot without the present invention in a wire frame mode or the like, it is possible to cause the driver to recognize that the corresponding image is the image of the portion which the driver can not see directly in actuality. Further, this display unit has a viewing angle which is suitable for the driver such that the passengers or the like do not see the unintuitive image. Further, the virtual viewpoint is set to the viewpoint from the driver's seat, so that the virtual viewpoint is set in association with the viewpoint of the driver.

### Sixth Embodiment

In the third to the fifth embodiments, the case in which the present invention is applied to a vehicle has been mainly explained. However, the present invention can be applied to wider technical scope, without being limited to the application of the vehicle. Accordingly, in a sixth embodiment of the present invention, an example is explained in which the present invention is applied to an application other than that of the vehicle.

In one example in the sixth embodiment of the present invention, the monitoring system can employ the configuration in which the observer is a person walking in a room or on a road, and the image acquisition arrangement object is a thing in/outside a room/building or a traveling object (vehicle, or robot). Additionally, the configuration in the sixth embodiment can be used for checking the blind spots that can be caused depending upon whether the door is closed or open, depending upon the status of electrical appliances or doors of furniture, or for checking the blind spot behind the person.

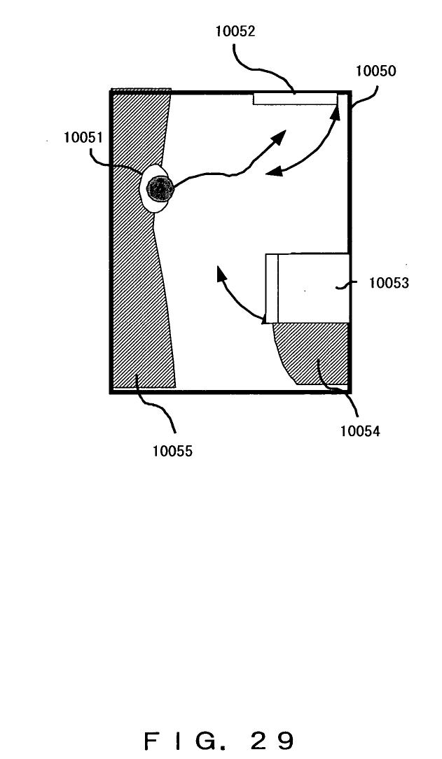

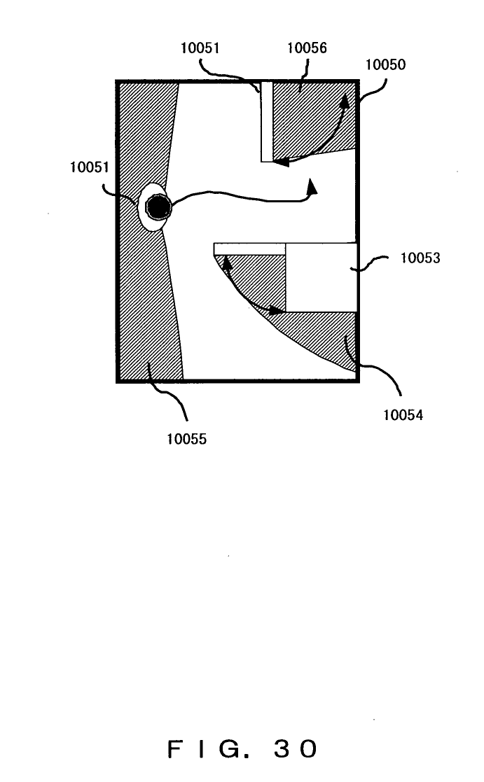

FIG. 29 and FIG. 30 show an example in the case in which the image generation device according to the sixth embodiment of the present invention is applied to the HMD (Head Mounted Display).

Shadow portions 10054, 10055 and 10056 in FIG. 29 and FIG. 30 are the blind spots. FIG. 29 shows the situation in which a door 10052 in a room 10050 and a door of a refrigerator 10053 are closed. FIG. 30 shows the situation in which the door 10052 in the room 10050 and the door of the refrigerator are open.

In this case, a person 10051 as the observer, wears the HMD or the like for example, can observe the virtual viewpoint image, and the position, the posture and the direction of the observer himself/herself whose images are acquired by the cameras in the camera unit arrangement object (the room 10050 in this example) are measured (these factors can be measured by the GPS, the gyrosensor, the camera device and the sight line detection device for human being worn by the person who is the observer).

It is possible to calculate the portion that the person can directly observe and the portion that the person cannot see, based on the above information. Thereby, the person can recognize the areas which are blind for him/her e.g., the blind spots 10054, 10055 and 10056 on the virtual viewpoint image displayed on the HMD or the like, accordingly, the person can recognize the danger for him/her such as a suspicious person, a dog, a vehicle, an open manhole or a ditch behind obstacles for example.

In the third to sixth embodiments, the cameras 2101 are used for generating the virtual viewpoint image, and these cameras can have an AF (Auto Focus) function. Thereby, when monitored targets are close to the camera for a stereo image, the setting is adjusted such that the focus is on the closer targets. In other words, the camera is adjusted to operate on the mode which is generally called a macro mode which is for the case of photographing at a position close to the subject to acquire an image in a large size. Thereby, the image in which the adjustment of focusing is performed suitably for the 3D reconfiguration can be acquired at a close distance.

Additionally, in the case in which images of subjects which are far from the camera are acquired, and thereby, the focus is on the far subjects by the AF function, highly accurate images of the far subjects can be obtained and the accuracy of the observation of the far subjects are improved.

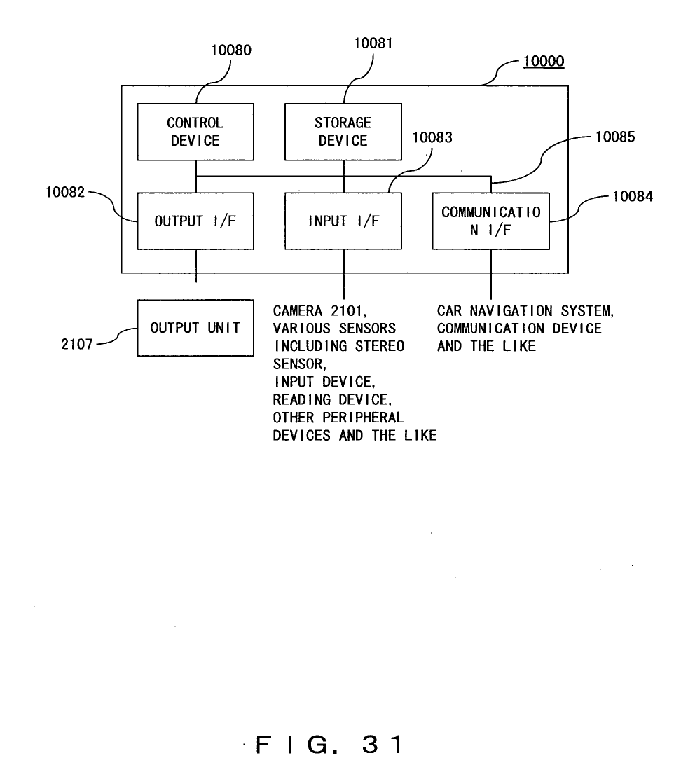

FIG. 31 is a block diagram of the configuration of the hardware of the image generation device 10000 according to the third to sixth embodiments. In FIG. 31, the image generation device 10000 comprises at least a control device 10080 such as for example a Central Processing Unit (CPU) or the like, a storage device 10081 such as read only memory (ROM), random access memory (RAM), a large capacity storage device or the like, an output interface (hereinafter, interface is referred to as I/F) 10082, an input I/F 10083, a communication I/F 10084 and a bus 10085 for connecting these components, and further comprises an output unit 2107 such as a display device or the like, and various devices connected to the input I/F or to the communication I/F.

As the devices which are to be connected to the input I/F, the camera 2101, an in-vehicle camera, various sensors including a stereo sensor, an input devices such as a keyboard, a mouse and the like, a reading device for a transportable storage medium such as a CD-ROM, a DVD or the like, and other peripheral devices and the like are can be used, for example.

As the devices that are to be connected to the communication I/F 10084, a car navigation system, or a communication device that is connected to the Internet or to the GPS can be used. Additionally, as the communication medium, the communication network such as the Internet, a LAN, a WAN, a dedicated circuit, a wired network, a wireless network and the like can be used.

As one example of the storage device 10081, various types of the storage devices such as a hard disk, a magnetic disk and the like can be used, and the programs expressed by the flows, the respective tables (for example, the table and the like which store the respective setting values), the CAD data and the like in the above third to sixth embodiments are stored in the storage device 10081. The control device 10080 reads these programs, and the respective processes described in the flow are executed.

It is possible that these programs are provided by a side of program providers by using the Internet and via the communication I/F 10084 and are stored in the storage device 10081, or are set in a commercially available transportable storage medium and executed by the control device when the transportable storage medium is connected to a reading device. As the transportable storage medium, various types of the storage media such as a CD-ROM, a DVD, a flexible disk, an optical disk, a magneto-optical disk an IC card can be used, and programs stored in such storage media are read by the reading device.

Additionally, as the input device, a keyboard, a mouse, a electronic camera, a microphone, a scanner, a sensor, a tablet and the like can be used. Further, other peripheral devices can be connected to the image generation device of the present invention.

In addition, in the above third to sixth embodiments, the plurality of camera units can be used in the configuration where the plurality of camera units constitute a so-called trinocular stereo camera or a quadocular stereo camera. It is known that when the trinocular stereo camera or the quadocular stereo camera is used as above, more reliable and more stable process results can be obtained in 3D reproduction processes and the like. (See “HIGH PERFORMANCE 3D VISUAL SYSTEM” fourth issue, vol. 42, Fumiaki TOMITA published by Information Processing Society of Japan, for example.) Especially, it is known that when the plurality of cameras are arranged in such a way that they have a two-directional baseline length, a 3D reconfiguration in a more complex scene is realized. Also, when the plurality of cameras are arranged in a direction of the baseline length, a stereo camera which is based on a so-called multi-baseline method is realized, thereby, a stereo measurement with higher accuracy is realized.

According to the present invention, a technique is realized, which improves convenience of a user interface of a display of a virtual viewpoint image.

1. An image generation device comprising
one or a plurality of image acquisition units which are mounted on an image acquisition unit arrangement object and which are for acquiring images,
a space reconfiguration unit for mapping the captured images acquired by the image acquisition units onto a spatial model,
a viewpoint conversion unit for producing viewpoint conversion image data of an image viewed from an arbitrary virtual viewpoint in a 3D space, based on spatial data obtained by the mapping by the space reconfiguration unit, and
a display unit for displaying the image viewed from the arbitrary virtual viewpoint in a 3D space, based on the viewpoint conversion image data produced by the viewpoint conversion unit, further comprising:
a distance calculation unit for calculating a distance between an image acquisition unit arrangement object model as a model of the image acquisition unit arrangement object and the spatial model, based on any of the viewpoint conversion image data produced by the viewpoint conversion unit, the captured image data expressing the captured image, the spatial model and the spatial data obtained by the mapping, wherein:
the display unit displays the image in a different manner in accordance with the distance calculated by the distance calculation unit.

2. The image generation device according to claim 1, wherein:
the display unit displays the image as a background model including the image when the distance calculated by the distance calculation unit is equal to or larger than a prescribed value.

3. The image generation device according to claim 1, wherein:
the display unit displays an image with a portion in a blurred state, when the portion whose distance calculated by the distance calculation unit is equal to or larger than a prescribed value is included in the image which is to be displayed.

4. An image generation device comprising
one or a plurality of image acquisition units which are mounted on an image acquisition unit arrangement object and which are for acquiring images,
a space reconfiguration unit for mapping the captured images acquired by the image acquisition units onto a spatial model,
a viewpoint conversion unit for producing viewpoint conversion image data of an image viewed from an arbitrary virtual viewpoint in a 3D space, based on spatial data obtained by the mapping by the space reconfiguration unit, and
a display unit for displaying the image viewed from the arbitrary virtual viewpoint in a 3D space, based on the viewpoint conversion image data produced by the viewpoint conversion unit, further comprising:
a relative velocity calculation unit for calculating a relative velocity between an image acquisition unit arrangement object model as a model of the image acquisition unit arrangement object and the spatial model, based on any of the viewpoint conversion image data at two time points which corresponds to different time points and which is produced by the viewpoint conversion unit, the captured image data expressing the captured image, the spatial model and the spatial data obtained by the mapping, wherein:
the display unit displays the image in a different manner in accordance with the relative velocity calculated by the relative velocity calculation unit.

5. An image generation device comprising
one or a plurality of image acquisition units which are mounted on an image acquisition unit arrangement object and which are for acquiring images,
a space reconfiguration unit for mapping the captured images acquired by the image acquisition units onto a spatial model,
a viewpoint conversion unit for producing viewpoint conversion image data of an image viewed from an arbitrary virtual viewpoint in a 3D space, based on spatial data obtained by the mapping by the space reconfiguration unit, and
a display unit for displaying the image viewed from the arbitrary virtual viewpoint in a 3D space, based on the viewpoint conversion image data produced by the viewpoint conversion unit, further comprising:
a collision probability calculation unit for calculating a probability of a collision between an image acquisition unit arrangement object model as a model of the image acquisition unit arrangement object and the spatial model, based on any of the viewpoint conversion image data which corresponds to different time points and which is produced by the viewpoint conversion unit, the captured image data expressing the captured image, the spatial model and the spatial data obtained by the mapping, wherein:
the display unit displays the image in a different manner in accordance with the probability of a collision calculated by the collision probability calculation unit.

6. The image generation device according to claim 5, wherein:
the display unit displays the image as a background model including the image when the probability of a collision calculated by the collision probability calculation unit is equal to or smaller than a prescribed value.

7. The image generation device according to claim 5, wherein:
the display unit displays an image with a portion in a blurred state, when the portion whose probability of a collision calculated by the collision probability calculation unit is equal to or smaller than a prescribed value is included in the image which is to be displayed.

8. The image generation device according to claim 1, wherein:
the display unit is configured so as to be able to employ the manner of the display such that a meaning of displayed information is recognized by a color.

9. The image generation device according to claim 1, wherein:
the display unit is configured so as to be able to employ a manner of a display in which at least one of hue, saturation and brightness of a color used for the display is different in accordance with the distance calculated by the distance calculation unit.

10. The image generation device according to claim 1, wherein:
the display unit is configured so as to be able to employ a manner of a display in which at least one of hue, saturation and brightness of a color used for the display is different in accordance with which of a plurality of grades defined by distance values calculated by the distance calculation unit the distance value calculated by the distance calculation unit corresponds to.

11. The image generation device according to claim 1, wherein:
the image acquisition unit is mounted on a vehicle.

12-45. (canceled)
